(19) United States
(12) Patent Application Publication
(10) Pub. No.: US 2024/0015697 A1
(43) Pub. Date: Jan. 11, 2024

(54) Method and System for Handling Paging of a Device based on a Predictive Model of a Future Need to Page the Device

(71) Applicant: Telefonaktiebolaget LM Ericsson (publ), Stockholm (SE)

(72) Inventors: Dinand Roeland, Sollentuna (SE); Göran Rune, Linköping (SE); Ricardo da Silva Souza, Indaiatuba (BR)

(21) Appl. No.: 18/252,129

(22) PCT Filed: Nov. 9, 2020
(86) PCT No.: PCT/SE2020/051077

§ 371 Date: May 8, 2023

(51) Int. Cl. H04W 68/02; H04W 68/04

(52) U.S. Cl. CPC H04W 68/02; H04W 68/04

(57) ABSTRACT

A method, performed by a first node (111). The first node (111) operates in a communications network (10). The first node (111) determines (202) a predictive model of a future need to page a device (133) operating in the communications network (10). The first node (111) then outputs (204) a first indication. The first indication is based on the determined predictive model. A second node (112) operating in the communications network (10) obtains (301) the first indication, and predicts (302), based on the obtained first indication, the future need to page the device (133). A third node (113) obtains (402) a third indication from the second node (112). The third indication indicates the predicted future need to page the device (133) operating in the communications network (10). The third node (113) then determines (403), based on the obtained third indication, whether or not to page the device (133).

### TECHNICAL FIELD

The present disclosure relates generally to a first node and methods performed thereby for handling a need to page a device. The present disclosure also relates generally to a third node, and methods performed thereby for handling a need to page a device. The present disclosure further relates generally to a fourth node and methods performed thereby for handling a need to page a device. The present disclosure also relates generally to computer programs and computer-readable storage mediums, having stored thereon the computer programs to carry out these methods.

### BACKGROUND

Computer systems in a communications network may comprise one or more nodes, which may also be referred to simply as nodes. A node may comprise one or more processors which, together with computer program code may perform different functions and actions, a memory, a receiving and a sending port. A node may be, for example, a server. Nodes in a computer network may control different aspects of the operation of the communications network. A node may be, for example, a core network node.

The standardization organization 3GPP is currently in the process of specifying a New Radio Interface called NR or 5G-UTRA, as well as a Fifth Generation (5G) Packet Core Network, which may be referred to as Next Generation (NG) Core Network, abbreviated as NG-CN, NGC or 5G CN.

In 5G CN, an example of a core network node may be the 3GPP Network Data Analytics Functions (NWDAF). The NWDAF may be understood as a node that may host several services for network data analytics. For example, a network function (NF) may subscribe to an NWDAF service for providing network slice congestion events. The specification for the NWDAF is under development in 3GPP, and multiple services are expected to be added. Some of these may be standardized, some may be kept proprietary. A list of services currently available in the NWDAF may be found in 3GPP TS 23.288, v. 16.5.0. An NWDAF has recently been developed that may be capable of predicting a next radio base station for a moving user device, e.g., a UE, with an Artificial Intelligence (AI) model.

Another example of core network node may be an Access Management Function (AMF), or the MME in 4G. The NWDAF may subscribe to the AMF for mobility events. Events may then sent be from AMF to NWDAF, where each event may contain information about a radio base station transition of a UE. Each event may include at least: a time stamp, a unique UE identifier, and an identifier of the new radio base station. The event may include additional information such as previous radio base station and the time elapsed at the previous radio base station, even though such information may also be deduced by the NWDAF from previously received events.

The communications network may cover a geographical area which may be divided into cell areas, each cell area being served by a network node, e.g., a radio network node or Transmission Point (TP), for example, an access node such as a Base Station (BS), e.g. a Radio Base Station (RBS), which sometimes may be referred to as e.g., evolved Node B (“eNB”), “eNodeB”, “NodeB”, “B node”, or BTS (Base Transceiver Station), depending on the technology and terminology used. The base stations may be of different classes such as e.g. Wide Area Base Stations, Medium Range Base Stations, Local Area Base Stations and Home Base Stations, based on transmission power and thereby also cell size. A cell is the geographical area where radio coverage is provided by the base station at a base station site. One base station, situated on the base station site, may serve one or several cells. Further, each base station may support one or several communication technologies. The communications network may also be a non-cellular system, comprising network nodes which may serve receiving nodes, such as user equipments, with serving beams.

In 3rd Generation Partnership Project (3GPP) Long Term Evolution (LTE), base stations, which may be referred to as eNodeBs or even eNBs, may be directly connected to one or more core networks. All data transmission in LTE is controlled by the radio base station.

Devices within a communications network may be user equipments (UEs), e.g., stations (STAs), wireless devices, mobile terminals, wireless terminals, terminals, and/or Mobile Stations (MS). User equipments are enabled to communicate wirelessly in a cellular communications network or wireless communication network, sometimes also referred to as a cellular radio system, cellular system, or cellular network. The communication may be performed e.g., between two user equipments, between a user equipment and a regular telephone, and/or between a user equipment and a server via a Radio Access Network (RAN), and possibly one or more core networks, comprised within the communications network. User equipments may further be referred to as mobile telephones, cellular telephones, laptops, or tablets with wireless capability, just to mention some further examples. The user equipments in the present context may be, for example, portable, pocket-storable, hand-held, computer-comprised, or vehicle-mounted mobile devices, enabled to communicate voice and/or data, via the RAN, with another entity, such as another terminal or a server.

When a UE does not receive or send any data, the network may instruct the UE to go into idle mode. This may be understood as a sleep mode to save battery time. In idle mode, the signaling between UE and network may be kept to a minimum. However, the network may still need to be able to reach the UE; for example, when there may be incoming downlink data towards the UE. This may be understood to be where the so-called paging procedure may come in. A core network node, such as e.g., the Access Management Function (AMF) in 5G CN, may instruct the base station where the UE may have been last detected to broadcast a message “UE, are you there?”. If the UE does not reply, then the AMF may instruct neighboring base stations to broadcast that message. If still no reply is received, additional neighbors may be asked, until the UE may reply.

Without any further measure, the paging procedure above is inefficient. In the worst-case scenario, all radio base stations in the network may send the broadcast message to find the UE. To improve efficiency, the concept of tracking areas may be used. Each radio base station, or even each cell of each radio base station, may regularly send a broadcast message with a Tracking Area Code (TAC). Along with this code, the broadcast may also include the network identity of the operator. TAC combined with network identity may be understood to form the Tracking Area Identity (TAI). Multiple cells and multiple radio base stations may broadcast the same TAI. There may be one unique TAI for each tracking area (TA). What TAI to broadcast may be configured once and may not be changed on-the-fly.

Each UE may be configured with a list of TAIs. The UE may receive this list from the AMF at initial registration, that is at the initial attachment, and the AMF may change the TAI list of a UE over time. When an idle UE moves within its TAI list, it may not need to contact the network. The only exception may be that it may send an “I am still alive” message at regular intervals, typically once per hour. But when a UE moves outside its TAI list, it may need to contact the network to ask for an updated TAI list. These messages may be known as “Tracking Area Update” (TAU) messages in 4G or “Periodic Registration Area Update” (RAU) messages in 5G. In this document, the terms “tracking area” and “registration area”, as defined in e.g., 3GPP TS 23.501, v. 16.6.0 and 3GPP TS 23.401, v. 16.8.0, may be used interchangeably.

When dimensioning the network, a balance may be understood to need to be found. On one hand, TAI lists spanning a large geographical area will lead to few TAU messages, but lots of paging messages. On the other hand, TAI lists spanning a small geographical area will lead to few paging messages, but many TAU messages.

The paging procedure may take time. When a downlink packet arrives while the UE is idle, the packet may be buffered until the paging procedure has finished. Only then may the packet be forwarded to the UE. In other words, the design of the network implies that the end user application at the UE may experience delays in the delivery of packets. If an application for which the packets may arrive is sensitive to this delay, the application, or the UE itself, may ensure that the UE never enters the idle state. However, that may be understood to cost energy and thereby battery.

According to the foregoing, paging of a UE with existing methods may lead to waste of network resources, as well as delays and wasted battery for the UE.

### SUMMARY

It is an object of embodiments herein to improve the handling of a need to page a device in a communications network.

In general terms, embodiments herein may be understood to be drawn to pro-active paging. More particularly, embodiments herein, may be understood to be drawn to a node which, using an AI model, may be able to predict when a downlink packet may arrive. With that information, the node may be enabled to pro-actively page the UE, so that at the downlink packet arrival time, the UE may already be in connected mode. The downlink packet may as a result immediately be delivered to the UE without having to wait for paging. As a result, an application for which the packet may be delivered, may no longer experience a delay in packet delivery.

According to a first aspect of embodiments herein, the object is achieved by a method, performed by a first node. The first node operates in the communications network. The first node determines a predictive model of a future need to page a device operating in the communications network. The first node also outputs a first indication. The first indication is based on the determined predictive model.

According to a second aspect of embodiments herein, the object is achieved by a method, performed by a second node. The second node operates in the communications network. The second node obtains the first indication from the first node operating in the communications network. The first indication indicates the determined predictive model of the future need to page the device operating in the communications network. The second node predicts, based on the obtained first indication, the future need to page the device.

According to a third aspect of embodiments herein, the object is achieved by a method, performed by a third node. The third node operates in the communications network. The third node obtains a third indication from the second node operating in the communications network. The third indication indicates the predicted future need to page the device operating in the communications network. The third node also determines, based on the obtained third indication, whether or not to page the device.

According to a fourth aspect of embodiments herein, the object is achieved by the first node. The first node is configured to operate in the communications network. The first node is further configured to determine the predictive model of the future need to page the device configured to operate in the communications network. The first node is additionally configured to output the first indication. The first indication is configured to be based on the predictive model configured to be determined.

According to a fifth aspect of embodiments herein, the object is achieved by the second node. The second node is configured to operate in the communications network. The second node is further configured to obtain the first indication from the first node configured to operate in the communications network. The first indication is configured to indicate the determined predictive model of the future need to page the device configured to operate in the communications network. The second node is further configured to predict, based on the obtained first indication, the future need to page the device.

According to a sixth aspect of embodiments herein, the object is achieved by the third node. The third node is configured to operate in the communications network. The third node is further configured to obtain the third indication from the second node configured to operate in the communications network. The third indication is configured to indicate the predicted future need to page the device configured to operate in the communications network. The third node is further configured to determine, based on the third indication configured to be obtained, whether or not to page the device.

According to a sixth aspect of embodiments herein, the object is achieved by a computer program, comprising instructions which, when executed on at least one processor, cause the at least one processor to carry out the method performed by the first node.

According to a seventh aspect of embodiments herein, the object is achieved by a computer-readable storage medium, having stored thereon the computer program, comprising instructions which, when executed on at least one processor, cause the at least one processor to carry out the method performed by the first node.

According to an eighth aspect of embodiments herein, the object is achieved by a computer program, comprising instructions which, when executed on at least one processor, cause the at least one processor to carry out the method performed by the second node.

According to a ninth aspect of embodiments herein, the object is achieved by a computer-readable storage medium, having stored thereon the computer program, comprising instructions which, when executed on at least one processor, cause the at least one processor to carry out the method performed by the second node.

According to a tenth aspect of embodiments herein, the object is achieved by a computer program, comprising instructions which, when executed on at least one processor, cause the at least one processor to carry out the method performed by the third node.

According to an eleventh aspect of embodiments herein, the object is achieved by a computer-readable storage medium, having stored thereon the computer program, comprising instructions which, when executed on at least one processor, cause the at least one processor to carry out the method performed by the third node.

By determining the predictive model, the first node may be understood to be enabled, to predict when the device may need to be paged in the future itself, or to enable another node, such as e.g., the second node to do the same. By outputting the first indication, the first node, depending on the content of the first indication, and the node the first indication may be output to, may be enable itself or another node, such as e.g., the second node, to predict the need to page the device in the third time period, or may to notify another node, such as the third node, or one of the one or more other nodes, of the need to page the device. The first node may even be enabled to send a paging request to the device. Independently of who may eventually predict when the device may need to be paged in the future, this prediction may be understood to enable that the device may be paged ahead of the third time period and whenever a downlink packet may arrive, the device may already be in connected mode. This may be understood to then enable to avoid delay in packet delivery, which may otherwise be required to page the device and set it in connected mode.

By obtaining the first indication, the second node may be understood to be enabled to execute the predictive model and predict the future need to page the device. By predicting the need to page the device in the third time period, the second node may be enabled to send the third indication to the third node.

By obtaining the third indication, predicting the need to page the device, the third node may be understood to be enabled to determine, based on the obtained third indication, whether or not to page the device. By determining whether or not to page the device based on the third indication, the third node may be understood to be enabled to page the device ahead of the third time period so that whenever a downlink packet may arrive, the device may already be in connected mode. This may be understood to then enable to avoid delay in packet delivery, which may otherwise be required to page the device and set it in connected mode.

### BRIEF DESCRIPTION OF THE DRAWINGS

Examples of embodiments herein are described in more detail with reference to the accompanying drawings, according to the following description.

FIG. 1 is a schematic diagram illustrating a non-limiting example of a communications network, according to embodiments herein.

FIG. 2 is a flowchart depicting embodiments of a method in a first node, according to embodiments herein.

FIG. 3 is a flowchart depicting embodiments of a method in a second node, according to embodiments herein.

FIG. 4 is a flowchart depicting embodiments of a method in a third node, according to embodiments herein.

FIG. 5 is a flowchart depicting embodiments of a method in a first node, according to embodiments herein.

FIG. 6 is a flowchart depicting embodiments of a method in a first node, according to embodiments herein.

FIG. 7 is a schematic block diagram illustrating two non-limiting examples, a) and b), of a first node, according to embodiments herein.

FIG. 8 is a schematic block diagram illustrating two non-limiting examples, a) and b), of a second node, according to embodiments herein.

FIG. 9 is a schematic block diagram illustrating two non-limiting examples, a) and b), of a third node, according to embodiments herein.

### DETAILED DESCRIPTION

Certain aspects of the present disclosure and their embodiments address one or more of the issues with the existing methods discussed in the background section and provide solutions to the challenges discussed.

The embodiments will now be described more fully hereinafter with reference to the accompanying drawings, in which examples are shown. In this section, embodiments herein are illustrated by exemplary embodiments. It should be noted that these embodiments are not mutually exclusive. Components from one embodiment or example may be tacitly assumed to be present in another embodiment or example and it will be obvious to a person skilled in the art how those components may be used in the other exemplary embodiments. All possible combinations are not described to simplify the description.

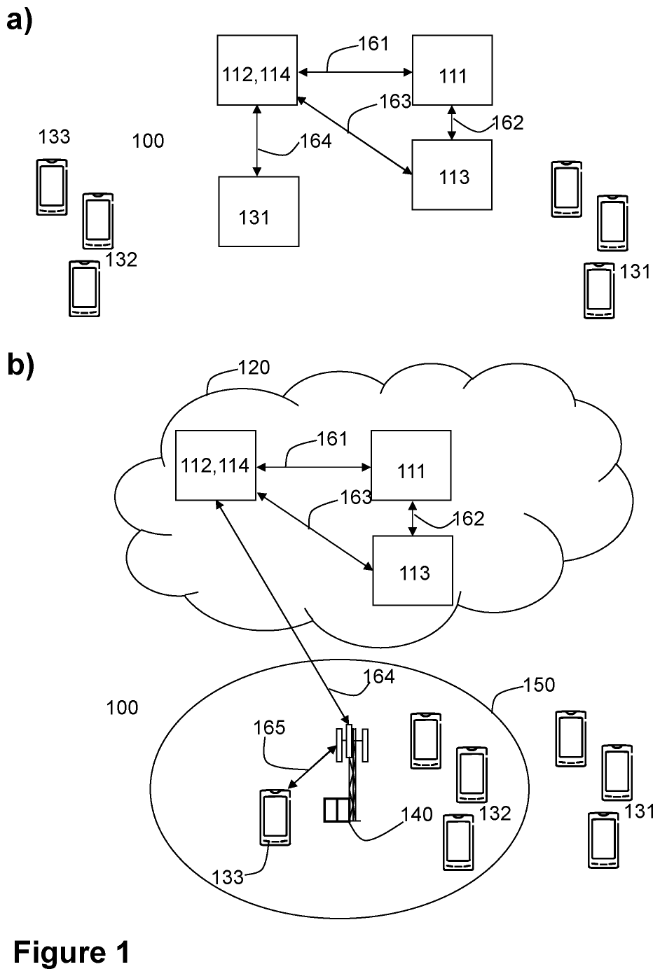

FIG. 1 depicts two non-limiting examples, in panels “a” and “b”, respectively, of a communications network 10, in which embodiments herein may be implemented. In some example implementations, such as that depicted in the non-limiting example of FIG. 1a, the communications network 10 may be a computer network. In other example implementations, such as that depicted in the non-limiting example of FIG. 1b, the communications network 10 may be implemented in a telecommunications network 100, sometimes also referred to as a cellular radio system, cellular network or wireless communications system. In some examples, the telecommunications network may comprise network nodes which may serve receiving nodes, such as wireless devices, with serving beams.

In some examples, the telecommunications network 100 may for example be a network such as 5G system, or Next Gen network, or a newer system supporting similar functionality. The telecommunications network 100 may also support other technologies, such as a Long-Term Evolution (LTE) network, e.g. LTE Frequency Division Duplex (FDD), LTE Time Division Duplex (TDD), LTE Half-Duplex Frequency Division Duplex (HD-FDD), LTE operating in an unlicensed band, Wideband Code Division Multiple Access (WCDMA), Universal Terrestrial Radio Access (UTRA) TDD, Global System for Mobile communications (GSM) network, GSM/Enhanced Data Rate for GSM Evolution (EDGE) Radio Access Network (GERAN) network, Ultra-Mobile Broadband (UMB), EDGE network, network comprising of any combination of Radio Access Technologies (RATs) such as e.g. Multi-Standard Radio (MSR) base stations, multi-RAT base stations etc., any 3rd Generation Partnership Project (3GPP) cellular network, Wireless Local Area Network/s (WLAN) or WiFi network/s, Worldwide Interoperability for Microwave Access (WiMax), IEEE 802.15.4-based low-power short-range networks such as IPv6 over Low-Power Wireless Personal Area Networks (6LowPAN), Zigbee, Z-Wave, Bluetooth Low Energy (BLE), or any cellular network or system.

Although terminology from Long Term Evolution (LTE)/5G has been used in this disclosure to exemplify the embodiments herein, this should not be seen as limiting the scope of the embodiments herein to only the aforementioned system. Other wireless systems, support similar or equivalent functionality may also benefit from exploiting the ideas covered within this disclosure. In future radio access, e.g., in the sixth generation (6G), the terms used herein may need to be reinterpreted in view of possible terminology changes in future radio access technologies.

The communications network 10 may comprise a plurality of nodes, whereof a first node 111, a second node 112, a third node 113, and one or more other nodes 114, which may be understood to be one or more fourth nodes 114, are depicted in FIG. 1. Any of the first node 111, the second node 112, the third node 113, and the one or more other nodes 114 may be understood, respectively, as a first computer system, a second computer system, a third computer system, and one or more fourth computer systems. In some examples, any of the first node 111, the second node 112, the third node 113, and the one or more other nodes 114 may be implemented as a standalone server e.g., a host computer in the cloud 120. Any of the first node 111, the second node 112, the third node 113, and the one or more other nodes 114 may in some examples be a distributed node or distributed server, with some of their respective functions being implemented locally, e.g., by a client manager, and some of its functions implemented in the cloud 120, by e.g., a server manager. Yet in other examples, any of the first node 111, the second node 112, the third node 113, and the one or more other nodes 114 may also be implemented as processing resources in a server farm.

In some embodiments, any of the first node 111, the second node 112, the third node 113, and the one or more other nodes 114 may be independent and separated nodes. In other embodiments, any of the first node 111, the second node 112, the third node 113, and the one or more other nodes 114 may be co-located or be the same node. In the non-limiting example depicted in FIG. 1, there is only one other node 114, and it is the same node as the second node 113.

All the possible combinations are not depicted in FIG. 1 to simplify the Figure. In some examples of embodiments herein, the first node 111 may be node having a capability to train and build an Artificial Intelligence (AI) model, e.g., it may be a function hosting a paging prediction model. The first node 111 may be, for example, a Network Data Analytics Function (NWDAF), e.g., in 5G, or a node capable of performing a similar function in the communications network 10. The second node 112 may be node having a capability to use or execute the AI model that may have been trained by the first node 111. In typical examples, the second node 112 may be the same NWDAF as the first node 111, although this need not be necessarily the case. The third node 113 may be understood as a node having a capability to manage paging of a device in the communications network 10. For example, the third node 113 may be an Access Management Function (AMF), e.g., in 5G, or a node capable of performing a similar function in the communications network 10. In other examples, the third node 113 may be a Radio Access Network node, such as the radio network node 140 described below. Any of the one or more other nodes 114 may be understood as nodes having a capability to gather data related to paging of a device in the communications network 10. Any of the one or more other nodes 114 may be for example, an AMF, a User Plane Function (UPF), or a Centralized Unit Control Plane (CU-CP).

The communications network 10 comprises one or more first devices 131, and one or more second devices 132. The communications network 10 may also comprise a device 133, which may be comprised in any of the one or more first devices 131, the one or more second devices 132, or may not be comprised in any of the one or more first devices 131 and the one or more second devices 132. The one or more first devices 131 may be the same as the one or more second devices 132 or may share at least one device in common with the one or more second devices 132. Typically, the one or more first devices 131 and the one or more second devices 132 may be different groups of devices. The number of one or more first devices 131 and one or more second devices 132 represented in FIG. 1 is for illustrating purposes only and may be understood to be non-limiting. Any of the devices in the one or more first devices 131 and one or more second devices 132 may be also known as e.g., a user equipment (UE), wireless device, mobile terminal, wireless terminal and/or mobile station, mobile telephone, cellular telephone, or laptop with wireless capability, or a Customer Premises Equipment (CPE), just to mention some further examples. Any of the UEs in the one or more first devices 131 and one or more second devices 132 in the present context may be, for example, portable, pocket-storable, hand-held, computer-comprised, or a vehicle-mounted mobile device, enabled to communicate voice and/or data, via a RAN, with another entity, such as a server, a laptop, a Personal Digital Assistant (PDA), or a tablet computer, sometimes referred to as a tablet with wireless capability, or simply tablet, a Machine-to-Machine (M2M) device, a device equipped with a wireless interface, such as a printer or a file storage device, modem, Laptop Embedded Equipped (LEE), Laptop Mounted Equipment (LME), USB dongles, or any other radio network unit capable of communicating over a radio link in the communications network 10. Any of the devices in the one or more first devices 131 and one or more second devices 132 may be wireless, i.e., it may be enabled to communicate wirelessly in the communications network 10 and, in some particular examples, may be able support beamforming transmission. The communication may be performed e.g., between two devices, between a device and a radio network node, and/or between a device and a server. The communication may be performed e.g., via a RAN and possibly one or more core networks, comprised, respectively, within the communications network 10. In some particular embodiments, any of the UEs in the one or more first devices 131 and one or more second devices 132 may be IoT devices, e.g., NB IoT devices.

The communications network 10 may comprise one or more radio network nodes 140, whereof one radio network node is depicted in FIG. 1b. Each of the one or more radio network nodes 140 may typically be a base station or Transmission Point (TP), or any other network unit capable to serve a wireless device or a machine type node in the communications network 10. Any of the one or more radio network nodes 140 may be e.g., a 5G gNB, a 4G eNB, or a radio network node in an alternative 5G radio access technology, e.g., fixed or WiFi. Any of the one or more radio network nodes 140 may be e.g., a Wide Area Base Station, Medium Range Base Station, Local Area Base Station and Home Base Station, based on transmission power and thereby also coverage size. Any of the one or more radio network nodes 140 may be a stationary relay node or a mobile relay node. Any of the one or more radio network nodes 140 may support one or several communication technologies, and its name may depend on the technology and terminology used. Any of the one or more radio network nodes 140 may be directly connected to one or more networks and/or one or more core networks.

The communications network 10 covers a geographical area which may be divided into cell areas, wherein each cell area may be served by a radio network node, although, one radio network node may serve one or several cells. In the non-limiting example depicted in FIG. 1b, the radio network node depicted serves a cell 150.

The first node 111 may communicate with the second node 112 over a respective first link 161, e.g., a radio link or a wired link. The first node 111 may communicate with the third node 113 over a second link 162, e.g., a radio link or a wired link. The third node 113 may communicate with the second node 112 over a third link 163, e.g., a radio link or a wired link. Any of the one or more other nodes 114 may communicate with any of the one or more first devices 131 or one or more second devices 132 over or via a respective fourth link 164, e.g., a radio link or a wired link. Any of the one or more radio network nodes 140 may communicate with any of the devices in the one or more first devices 131 and/or one or more second devices 132 over a respective fifth link 165, e.g., a radio link, of which only one is represented in FIG. 1 to simplify it. Any of the one or more other nodes 114 may communicate with the first node 111 over a respective sixth link, e.g., a radio link or a wired link, which is not represented in the Figure.

Any of the first link 161, the second link 162, the third link 163, the respective fourth link 164, and the respective fifth link 165 may be a direct link or it may go via one or more computer systems or one or more core networks in the communications network 10, or it may go via an optional intermediate network. The intermediate network may be one of, or a combination of more than one of, a public, private or hosted network; the intermediate network, if any, may be a backbone network or the Internet; in particular, the intermediate network may comprise two or more sub-networks, which is not shown in FIG. 1.

In general, the usage of “first”, “second”, “third”, “fourth”, “fifth” and/or “sixth” herein may be understood to be an arbitrary way to denote different elements or entities, and may be understood to not confer a cumulative or chronological character to the nouns they modify.

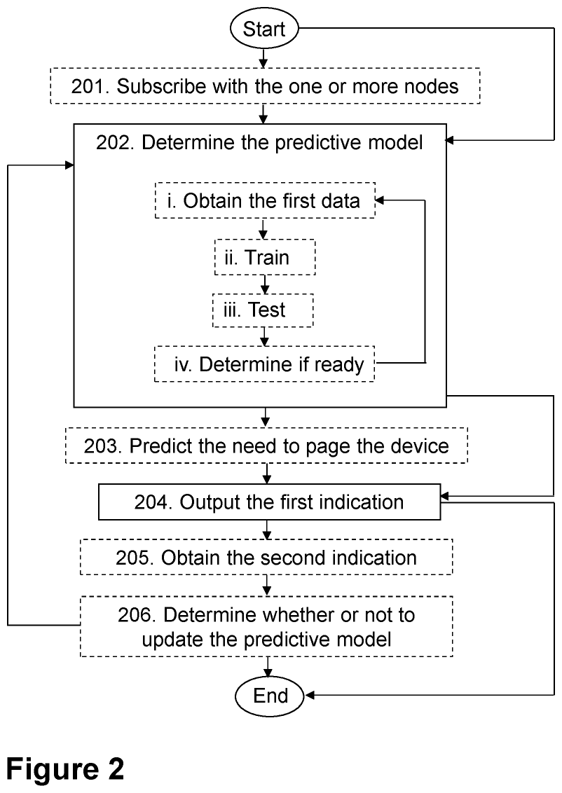

Embodiments of a computer-implemented method, performed by the first node 111, will now be described with reference to the flowchart depicted in FIG. 2. The method may be understood to be for handling a need to page a device. The first node 111 operates in the communications network 10.

The method may comprise the actions described below. In some embodiments some of the actions may be performed. In some embodiments all the actions may be performed. In FIG. 2, optional actions are indicated with dashed boxes. One or more embodiments may be combined, where applicable. All possible combinations are not described to simplify the description. It should be noted that the examples herein are not mutually exclusive. Components from one example may be tacitly assumed to be present in another example and it will be obvious to a person skilled in the art how those components may be used in the other examples.

Action 201

As mentioned earlier, embodiments herein may be understood to be drawn to enabling the performance of pro-active paging. For that purpose, the first node 111 may be understood to aim at building an AI predictive model to be able to predict when a certain device, such as the device 133, may need to be paged in the future, so that the device 133 may be paged ahead of the predicted time, and whenever a downlink packet may arrive, the device 133 may already be in connected mode. This may be understood to then enable to avoid delay in packet delivery, which may otherwise be required to page a device and set it in connected mode.

To be able to build such a predictive model, the first node 111 may first need to collect data to generate and train the predictive model. In order to collect the data, in this Action 201, the first node 111 may subscribe with the one or more other nodes 114 to receive data, e.g., first data, from one or more devices, e.g., the one or more first devices 131, operating in the communications network 10. The one or more first devices 131 may be understood to be the pool of devices from which the first data to train the predictive model may be obtained. This pool of devices may be understood to be the same, partly the same, or completely different than the pool of devices in which the predictive model may be eventually tested, and then the device 133 for which the predictive model may eventually be used to make actual predictions.

In general, the first data may be understood to be data that may relate to one or more aspects of paging, and that may enable the first node 111 to train a model to predict a need to page a device, such as the device 133. Accordingly, the first data may indicate one or more of the following options. Here, the connotation “first” may be understood to refer to a first set, or a training set. According to a first option, the first data may indicate first paging requests sent to the one or more first devices 131 over a first time period. The one or more first devices 131 may be operating in the communications network 10. According to a second option, the first data may indicate first transitions by the one or more first devices 131, over the first time period, between a first state wherein the one or more first devices 131 may have had an active connection with the communications network 10, e.g., they may have been in connected state such as RRC_connected, and a second state wherein the one or more first devices 131 had a standby connection with the communications network 10. A standby connection may be understood as a connection wherein the one or more devices 131 did not have a full connection with the communications network 10, that is, they may not have had e.g., the radio bearers and other settings in place to enable uplink and downlink transmission of data. Examples of the second state may be idle state, dormant state or inactive state. According to a third option, the first data may indicate a first mobility pattern of the one or more first devices 131. A mobility pattern may be understood herein as an indication of a mobility of a device. For example, a mobility pattern may be, in general, a list of base stations a device may visit, e.g., including time stamps for each visit, statistics based on historical data, or on predictions, or a combination thereof, etc. . . . . According to a fourth option, the first data may indicate a first location of the one or more first devices 131. According to a fifth option, the first data may indicate a first pattern of communications by the one or more first devices 131 in the communications network 10. The communications may be at least one of control communications and user plane communications. A user plane communication pattern may be understood as a description of the traffic by a user over time. A user plane communication pattern may comprise statistics based on historical data or predictions. For example, it may be possible to distinguish between user profiles, such as for example, a user typically uses video or voice, etc. . . . . A control plane communication pattern may be understood to be similar, but the communication may be understood to be about movement patterns, active and/or idle mode patterns, etc. For example, the pattern of communications may comprise uplink and downlink user plane communication patterns. According to a sixth option, the first data may indicate first services used by the one or more first devices 131 in the communications network 10. First services may be understood herein as video, voice, file downloads, real-time communication, best-effort, etc. It may be understood that different services may be typically associated with different needs to page the devices, which may therefore contribute to enabling the first node 111 to build the predictive model.

For any of the first to the fourth option, the first data may be obtained from an AMF. The communication pattern may typically be obtained from a User Plane Function (UPF). Any of the above data items may also be obtained from one or more intermediate buses, databases or nodes that may distribute data to several consumers, wherein the first node 111 may be one such consumer.

The first node 111 may subscribe to the one or more other nodes 114 for paging events so that the one or more other nodes 114 may then inform the first node 111 every time any of the one or more first devices 131 may get paged, which may be understood to be able to happen many times. The subscription may be to enable the first node 111 to receive a report from the one or more other nodes 114 with the time when the paging started, the device that was paged, and the reason for paging. Normally, the reason for paging any of the devices may be a downlink packet that may need to be sent to an idle UE. In that case, the reason may include the source address of the downlink packet, that is, the identifier (ID) of the originator of the downlink packet. Accordingly, in some embodiments, the first data may comprise at least one of: a respective first time paging started, a respective identifier of the one or more devices 132, a respective second time period it took to locate the one or more devices 132 and a respective reason for paging.

In particular embodiments, the first node 111 may be a NWDAF, and the at least one of the one or more other nodes 114 may be one of an AMF and a CU-CP. A paging request may also originate from another node, e.g., a Network Function (NF) in the communications network 10, when such NF may want to send a packet or message to a device, as for example described in 3GPP TS 23.502, v. 16.6.0 section 4.2.3.3 “Network Triggered Service Request”. The subscription may be to enable the first node 111 to receive a report from the one or more other nodes 114 with the time it took to find the device.

In some examples, the first node 111 may subscribe directly to the one or more other nodes 114. It may also be that any of the one or more other nodes 114 may already expose the first data to some other entity, or—in general—to some distributed database and/or bus. In that case, the first node 111 may subscribe to that database and/or bus.

In this Action 201, the first node 111 may also subscribe with the one or more other nodes 114 to receive second data from the one or more second devices 132 operating in the communications network 10. That is data equivalent to the first data, but for a different pool of devices, or for the same devices, during a different time period. This may be achieved by a single subscription. In this Action 201, the first node 111 may also subscribe with the one or more other nodes 114 to receive similar data about the device 133.

Action 202

In this Action 202, the first node 111, determines a predictive model of a future need to page the device 133 operating in the communications network 10. The predictive model may be understood as an AI predictive model.

Determining may be understood as calculating, deriving, generating, estimating, or similar.

The determining in this Action 202 may be performed using machine learning such as, for example, Random Forest and Bayesian Modelling, or based on analytics algorithms such as, e.g., linear regression, logistic Regression, classification and Regression Trees, etc.

The determining in this Action 202 may further comprise performing iteratively obtaining the first data and training the predictive model based on the obtained first data. Obtaining, may comprise receiving, collecting or gathering. In this Action 201, the obtaining may be implemented, e.g., via the respective sixth link, which may be in some examples the same as the first link 161. After subscription, the first node 111 may receive over time the series of paging requests for each of the one or more first devices 131. This information, comprised in the first data, may be used to train the paging prediction model. Besides this information, the training may use additional data such as UE mobility pattern, UE location, uplink and downlink user plane communication patterns, services used, etc. More particularly, as stated earlier, the first data may indicate one or more of the following options. According to the first option, the first data may indicate the first paging requests sent to the one or more first devices 131 over the first time period. The one or more first devices 131 may be operating, or may have operated, in the communications network 10. According to the second option, the first data may indicate the first transitions by the one or more first devices 131, over the first time period, between the first state wherein the one or more first devices 131 may have had an active connection with the communications network 10 and the second state wherein the one or more first devices 131 had the standby connection with the communications network 10. According to the third option, the first data may indicate the first mobility pattern of the one or more first devices 131. According to the fourth option, the first data may indicate the first location of the one or more first devices 131. According to the fifth option, the first data may indicate the first pattern of communications by the one or more first devices 131 in the communications network 10. The communications may be at least one of control communications and user plane communications. According to the sixth option, the first data may indicate the first services used by the one or more first devices 131 in the communications network 10.

Training may be performed in several ways, including supervised training locally, reinforcement learning, or learning in a federated fashion. Model training may be done on different scope; for example, per UE, or per UE type or per region.

Once the predictive model is trained, the first node 111 may start testing the predictive model by letting it predict the next paging request for a UE and compare that to actual paging request notifications coming from, e.g., the one or more other nodes 114, for example an AMF. By testing the trained predictive model, the first node 111 may be able to measure the accuracy of the predictive model, that is, how well, the predictive model is able to predict the need to page the device 133. In some embodiments, the determining in this Action 202 may further comprise performing iteratively testing an accuracy of the determined predictive model with second data, that is new pool of data similar to the first data obtained to test the predictive model, and one of the following two options. According to a first option, determining the determined predictive model is ready to be used with the proviso that the accuracy exceeds a threshold. According to a second option, continuing the training of the determined predictive model with the proviso that the accuracy is lower than the threshold. That is, the first node 111 may continue to train the predictive model until the accuracy may be good enough, that is, above a certain minimum threshold. After that, the predictive model may be taken into service.

The second data may indicate one or more of: a) second paging requests sent to the one or more second devices 132 operating, or having operated, in the communications network 10 over a second time period, b) second transitions by the one or more second devices 132, over the second time period, from the first state wherein the one or more second devices 132 had an active connection with the communications network 10 to the second state wherein the one or more second devices 132 had a standby connection with the communications network 10, c) a second mobility pattern of the one or more second devices 132, d) a second location of the one or more second devices 132, e) a second pattern of communications by the one or more second devices 132 in the communications network 10, and f) second services used by the one or more second devices 132 in the communications network 10. The one or more second devices 132 may be understood to be the pool of devices from which the second data to test the predictive model may be obtained. This pool of devices may be understood to be the same, partly the same, or completely different than the one or more first devices 131, and than the device 133 for which the predictive model may eventually be used to make actual predictions.

For any of the options a)-d), the second data may be obtained from an AMF. The communication pattern may typically be obtained from a User Plane Function (UPF). Any of the above data items may also be obtained from one or more intermediate buses, databases or nodes that may distribute data to several consumers, wherein the first node 111 may be one such consumer.

The first node 111 may obtain the second data based on the subscription performed in Action 201.

In embodiments wherein the accuracy may be lower than the threshold, the first node 111 may determine to re-train a new version of the predictive model while current version the predictive model may be actively used. Otherwise, the first node 111 may take the current predictive model out of active use and re-train.

By determining the predictive model in this Action 202, the first node 111 may be understood to be enabled, to predict when the device 133 may need to be paged in the future, as described in the next Action 203, or to enable another node, such as e.g., the second node 112 to do the same by performing Action 204, as described later.

Action 203

In some embodiments, the accuracy may exceed the threshold. That is, the ability of the predictive model to correctly predict the need to page a device may be satisfactory. In such embodiments, the first node 111 may, in this Action 203, predict the need to page the device 133 in a third time period based on the determined predictive model. The first node 111 may collect relevant data about the device 133, for example, input these data to the predictive model, and obtain a predicted need to page the device 133 at a future time period.

As mentioned earlier, in some embodiments, the first node 111 may be a NWDAF. Separate model execution for idle mode and RRC inactive state paging respectively may also be performed. For example, a core network node such as the AMF may have a model for pro-active paging, when the device 133 is idle, and a RAN node may have another model for pro-active paging when the device 133 may be in RRC inactive mode. It may be noted that RRC inactive may be understood as a RAN-internal state. In such state the device 133 may be idle, but core network, e.g., the AMF, may believe it is connected. With a separate model execution, the model for RRC inactive state may be executed in a non-Real-Time RAN Intelligent Controller (non-RT RIC) in an Open Radio Access Network (O-RAN) architecture. Model execution integrated with the CU-UP, e.g., in the near-RT RIC, may also be performed.

By predicting the need to page the device 133 in the third time period in this Action 203, the first node 111 may be understood to be enabled to enable that the device 133 may be paged ahead of the third time period so that whenever a downlink packet may arrive, the device 133 may already be in connected mode. This may be understood to then enable to avoid delay in packet delivery, which may otherwise be required to page the device 133 and set it in connected mode.

Action 204

In this Action 204, the first node 111 may output a first indication. The first indication may be based on the determined predictive model.

Outputting may be understood as e.g., providing, or sending, for example, via any of the first link 161, and the second link 162.

Embodiments herein may be understood to be described in the context of 3GPP CNs. In 5G, the device 133 may be in “RCC Inactive” state. This may be understood to mean that the device 133 may be in idle mode, but the RAN may not expose this to the CN. From the CN perspective, the device 133 may be in connected mode. In such scenario, it may be understood to be up to RAN to perform the paging.

Consequently, in some examples the first node 111 may execute the paging prediction model and trigger the paging itself, while in others, the first node 111 may provide the prediction to another node, such as the second node 112.

According to the foregoing, in some examples, the first node 111 may only have the capability to build and train the predictive model. In such examples, the first indication may indicate the predictive model, e.g., the function describing the predictive model. In such examples, the first indication may be provided to another node which may itself have the capability to run the predictive model, such as the second node 112.

In yet other examples, the first node 111 may not only have the capability to build the predictive model, but also to execute it. That is, the first node 111 may be the same as the second node 112. However, the first node 111 may not have the capability of itself paging the device 133. In such examples, the first indication but may be a prediction notification to another node which may itself have the capability to page the device 133, such as the third node 113.

In other examples, the first node 111 itself may also have the capability to page the device 133. That is, the first node 111 may be the same as the second node 112, and as the third node 113. Accordingly, in some embodiments, the output first indication may be based on the predicted need. For example, the first indication may be a paging request to the device 133. Once in service, the first node 111 may request a paging for the device 133 based on prediction. If the predictive model predicts a paging request to come at time=x, the first node 111 may initiate a paging request at time=x−y, where y may be a value indicating the time it may normally take to find the device 133. The result may be that, at time=x, the device 133 may already be in connected mode. The downlink packet may immediately go to the device 133 without having to wait for paging. Note that the value y may be part of the prediction model, and thus changed based on the training data.

According to the foregoing, in some embodiments, the first indication may indicate one of: the determined predictive model, a predicted future need to page the device 133, an instruction to page the device 133 and a recommendation to page the device 133.

More particularly in some embodiments, the outputting in this Action 204 may comprise sending the first indication to one of the following. According to a first option, the outputting in this Action 204 may comprise sending the first indication to the second node 112 operating in the communications network 10. In such embodiments, the first indication may indicate the determined predictive model. According to a second option, the outputting in this Action 204 may comprise sending the first indication to the third node 113 operating in the communications network 10. In such embodiments, the first indication may indicate the predicted future need to page the device 133 based on the predictive model. According to a third option, the outputting in this Action 204 may comprise sending the first indication to at least one of the one or more other nodes 114 operating in the communications network 10. The at least one of the one or more other nodes 114 may have subscribed to receive the first indication. In such embodiments, the outputting 204 may be based on the received subscription.

The embodiments herein may be understood to be able to be generalized such that they may be used at both the CN level and the RAN level. The first indication may be provided to any subscribing network function, e.g. the AMF in the CN, to handle UEs in idle state and the CU-CP, in the RAN, to handle UEs in RRC inactive state. In this way, the paging trigger or the paging prediction may be provided to a CU-UP if the device 133 is in RRC inactive state, and thus in connected mode from a CN perspective, and to the AMF if the device 133 is in idle mode, and thus RRC Idle from a RAN perspective.

In embodiments wherein the first node 111 may be NWDAF and it may output the first indication by sending in this Action 204 a paging request to an AMF, this Action 204 may be performed, e.g., as per 3GPP TS 23.502, v. 16.6.0, section 4.2.3.3 “Network Triggered Service Request” where the entity triggering the request is the NWDAF. Alternatively, instead of the first node 111 taking the initiative to page, the third node 113, e.g., an AMF, may subscribe to a new analytics service from the second node 112, which may be the same as the first node 111, which may be called “paging prediction”. When subscribed, the third node 113 may then receive predictions that may indicate when a paging may be recommended to be performed. This approach may be understood to provide the third node 113 more control and may better suit the NWDAF role in the 3GPP Rel-16/Rel-17specification for the first node 111.

By outputting the first indication, the first node 111, depending on the content of the first indication, may be enable another node, such as e.g., the second node 112, to predict the need to page the device 133 in the third time period, or may to notify another node, such as the third node 113, or one of the one or more other nodes 114, of the need to page the device 133, or send a paging request to the device 133, so that the device 133 may be paged ahead of the third time period and whenever a downlink packet may arrive, the device 133 may already be in connected mode. This may be understood to then enable to avoid delay in packet delivery, which may otherwise be required to page the device 133 and set it in connected mode.

Action 205

The determined predictive model may still produce incorrect predictions. Model prediction accuracy may even degrade over time, which is known as concept drift. Incorrect predictions may be understood to be costly, since they may be understood to force a device to be in connected state, which costs battery. Therefore, it may be understood to be important for the first node 111 to detect incorrect predictions, and re-train the predictive model when prediction accuracy may drop below the set threshold.

One way for the first node 111 to find out that it, or another node such as the third node 113, incorrectly sent a paging request, may be to monitor that a downlink packet really arrived at time=x (+/−a certain margin). If the packet never arrived, the prediction was incorrect. This solution may be understood to require the first node 111 to also monitor the user plane. If the packet arrived, and the device 133 was idle, then the first node 111 may conclude that a paging must have happened.

Another way for the first node 111 to find out that it, or another node such as the third node 113, incorrectly sent a paging request, may be to monitor when the RAN may time out a device, e.g., the device 133, due to inactivity. If for example the predictive model recommended to page the device 133, but the downlink packet never came, and the RAN times out the device 133 and instructs the device 133 to go to idle again. If the first node 111 or another node on its behalf monitors the connected-to-idle transitions, listens to the instruction to go the idle, and knows the time out value, it may deduce that the predicted paging was incorrect. The first node 111 may conclude that there was no activity since time=x, indicating that the downlink packet never arrived. This solution may be understood to require the first node 111 to register, with any of the one or more other nodes 114, the second node 112, or with the third node 113, e.g., an AMF, for notifications of the device going to idle.

It may also be possible that a paging may happen which the first node 111 may not have predicted, or that the paging happened at a time before the predicted time. Such events may still be seen by the first node 111 due to its subscription on paging requests.

To summarize, when the predictive model may be not in-service, the third node 113 may provide the first node 111 with the time series of when each UE may be paged. When the predictive model is in-service, the first node 111 may still deduce the time series given the missed predictions, such as that a paging happened that was not predicted, the incorrect predictions, such as that no packet came at time=x+/−a certain margin, and the correct predictions, such as that a packet came at time=x+/−a certain margin. This may be understood to mean that (re-) training may be done at any time, regardless if the predictive model may be in-service or not.

According to the foregoing, in this Action 205, the first node 111 may obtain a second indication. The second indication may indicate, e.g., explicitly or implicitly, at least one of: i) whether or not the device 133 was paged within the third time period, and ii) whether or not the device 133 was paged at another time period. The second indication may be obtained from any of the one or more other nodes 114, the second node 112, or the third node 113, e.g., an AMF.

By obtaining the second indication in this Action 205, the first node 111 may be enabled to obtain feedback about the accuracy of the determined predictive model, be enabled to determine whether or not to update the determined predictive model, as described in the next Action 206.

Action 206

In some embodiments, the first node 111, in this Action 206, may determine whether or not to update the determined predictive model based on the obtained second indication. If the obtained second indication indicates that the prediction made by the first node 111 was incorrect, the first node 111 may determine to update the determined predictive model, and it may return to Action 201 or Action 202 and perform the remaining actions. If the obtained second indication indicates that the prediction made by the first node 111 was correct, the first node 111 may determine to refrain from updating the determined predictive model, and may continue to e.g., make predictions based on it.

The first node 111 may determine to re-train a new version of the predictive model while current version the predictive model may be actively used. Otherwise, the first node 111 may take the current predictive model out of active use and re-train.

By determining whether or not to update the determined predictive model based on the obtained second indication in this Action 205, the first node 111 may be enabled to increase the increase the accuracy of the predictive model, by re-training the predictive model if the accuracy of the predictive model falls below a desired threshold.

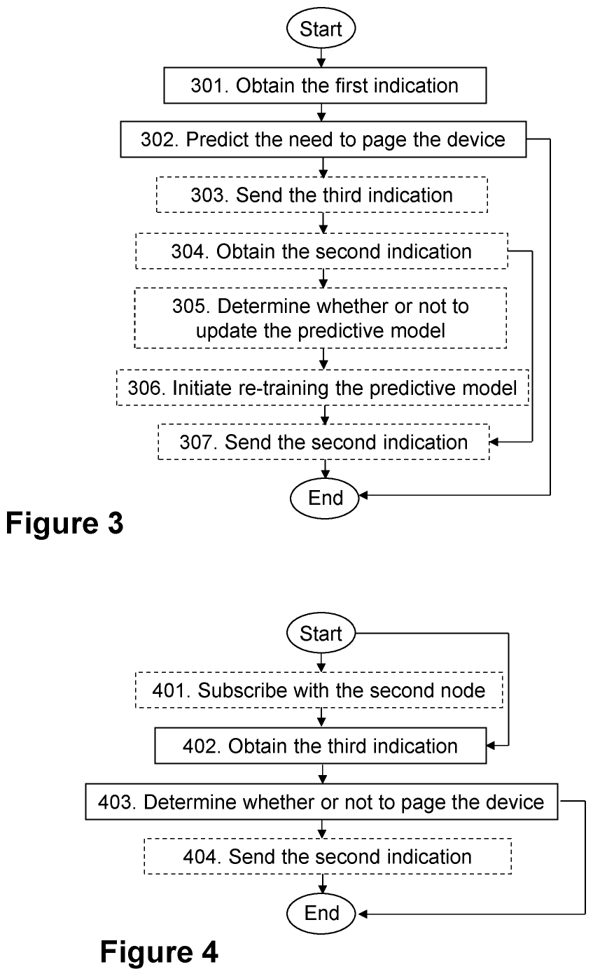

Embodiments of a computer-implemented method performed by the second node 112, will now be described with reference to the flowchart depicted in FIG. 3. The method may be understood to be for handling a need to page a device. The second node 112 operates in the communications network 10.

The method may comprise the following actions. Several embodiments are comprised herein. In some embodiments, some actions may be performed, in other embodiments, all actions may be performed. One or more embodiments may be combined, where applicable. All possible combinations are not described to simplify the description. It should be noted that the examples herein are not mutually exclusive. Components from one example may be tacitly assumed to be present in another example and it will be obvious to a person skilled in the art how those components may be used in the other examples. In FIG. 3, an optional action is represented in a box with dashed lines.

The detailed description of some of the following corresponds to the same references provided above, in relation to the actions described for the first node 111 and will thus not be repeated here to simplify the description. For example, the second node 112 may be the same node as the first node 111. In some particular examples, the second node 112 may be a NWDAF.

Action 301

In this Action 301, the second node 112 obtains the first indication from the first node 111 operating in the communications network 10. The first indication indicates the determined predictive model of the future need to page the device 133 operating in the communications network 10.

Obtaining may be understood as e.g., receiving, for example, via the first link 161, or retrieving, e.g., from a memory.

As described earlier, the predictive model may be based on one or more of the following options. According to a first option, the predictive model may be based on the first paging requests sent to the one or more first devices 131 over the first time period. The one or more first devices 131 may be operating, or may have operated, in the communications network 10. According to the second option, the predictive model may be based on the first transitions by the one or more first devices 131, over the first time period, between the first state wherein the one or more first devices 131 may have had an active connection with the communications network 10 and the second state wherein the one or more first devices 131 had the standby connection with the communications network 10. According to the third option, the predictive model may be based on the first mobility pattern of the one or more first devices 131. According to the fourth option, the predictive model may be based on the first location of the one or more first devices 131. According to the fifth option, the predictive model may be based on the first pattern of communications by the one or more first devices 131 in the communications network 10. The communications may be at least one of control communications and user plane communications. According to the sixth option, the predictive model may be based on the first services used by the one or more first devices 131 in the communications network 10.

The predictive model may be further based on one or more of: a) the second paging requests sent to the one or more second devices 132 operating, or having operated, in the communications network 10 over the second time period, b) the second transitions by the one or more second devices 132, over the second time period, from the first state wherein the one or more second devices 132 had an active connection with the communications network 10 to the second state wherein the one or more second devices 132 had a standby connection with the communications network 10, c) the second mobility pattern of the one or more second devices 132, d) the second location of the one or more second devices 132, e) the second pattern of communications by the one or more second devices 132 in the communications network 10, and f) the second services used by the one or more second devices 132 in the communications network 10.

The predictive model may have the accuracy exceeding the threshold.

By obtaining the first indication in this Action 301, the second node 112 is enabled to execute the predictive model in the next Action 302, and therefore predict the future need to page the device 133.

Action 302

After obtaining the first indication, in this Action 302, the second node 102 predicts, based on the obtained first indication, the future need to page the device 133. That is, the second node 112 may execute the predictive model that may have been indicated by the first indication.

By predicting the need to page the device 133 in the third time period in this Action 302, the second node 112 may be enabled to send the third indication in the next Action 303.

Action 303

In this Action 303, the second node 112 may send a third indication to the third node 113 operating in the communications network 10. The third indication may indicate the predicted need to page the device 133.

The sending may be performed, e.g., via the third link 163.

In some embodiments, the third node 113 may be an AMF. In some particular examples, the third node 113 may be the same as at least one of the one or more other nodes 114.

In some examples, the second node 112 may then perform equivalent actions to Action 205 and Action 206, as they were described for the first node 111. In such examples, the second node 112 may then update the predictive model itself, if deemed necessary, or indicate to the first node 111 than an update may be necessary. Otherwise, the second node 112 may send the second indication to the first node 111, either having created it itself, or having obtained it from the third node 113.

By sending the third indication in this Action 203, the second node 112 may be understood to enable that the third node 113 may page the device 133 ahead of the third time period so that whenever a downlink packet may arrive, the device 133 may already be in connected mode. This may be understood to then enable to avoid delay in packet delivery, which may otherwise be required to page the device 133 and set it in connected mode.

Action 304

Similarly to what was described for the first node 111 in Action 205, in this Action 304, the second node 112 may obtain the second indication. The second indication may indicate, e.g., explicitly or implicitly, at least one of: i) whether or not the device 133 was paged within the third time period, and ii) whether or not the device 133 was paged at another time period. The second indication may be obtained from any of the one or more other nodes 114, or the third node 113, e.g., an AMF.

By obtaining the second indication in this Action 304, the second node 112 may be enabled to obtain feedback about the accuracy of the determined predictive model, be enabled to determine whether or not to update the determined predictive model, as described in the next Action 305.

Action 305

Similarly to what was described for the first node 111 in Action 205, in this Action 305, the second node 112 may determine whether or not to update the determined predictive model based on the obtained second indication. If the obtained second indication indicates that the prediction made by the second node 112 was incorrect, the second node 112 may determine to update the determined predictive model, and initiate retraining the predictive model in the next Action 306.

By determining whether or not to update the determined predictive model based on the obtained second indication in this Action 305, the second node 112 may be enabled to increase the accuracy of the predictive model, by, if the accuracy of the predictive model falls below a desired threshold, determining to re-train the predictive model itself, or determining to indicate to the first node 111 that the predictive model should be updated, e.g., by sending a new version of the second indication to the first node 111 in Action 307.

Action 306

In this Action 306, the second node 112 may initiate retraining the predictive model based on a result of the determination performed in Action 305, of whether or not to update the determined predictive model based on the obtained second indication. The second node 112 may perform the retraining of the predictive model similarly to how it was described for the first node 111 in Action 202, with new first data, that is, a new pool of data similar to the first data obtained to test the predictive model, which may be referred to third data, or indicate to the first node 111 that the predictive model should be updated. If the obtained second indication indicates that the prediction made by the second node 112 was correct, the second node 112 may determine to refrain from updating the determined predictive model, and may continue to e.g., make predictions based on it.

The second node 112 may determine to re-train a new version of the predictive model while current version the predictive model may be actively used. Otherwise, the second node 112 may take the current predictive model out of active use and re-train.

By initiating retraining of the predictive model based on the obtained second indication in this Action 306, the second node 112 may be enabled to increase the accuracy of the predictive model, by, if the accuracy of the predictive model falls below a desired threshold, re-training the predictive model itself, or indicating to the first node 111 that the predictive model should be updated, e.g., by sending a new version of the second indication to the first node 111 in the next Action 307.

Action 307

In this Action 307, the second node 112 may send the second indication, as obtained in Action 304, or modified, to the first node 111. The second indication may indicate, e.g., explicitly or implicitly, at least one of: i) whether or not the device 133 was paged within the third time period, and ii) whether or not the device 133 was paged at another time period. The second indication may in some examples, be based on a result of the determination performed in Action 305, and indicate, e.g., that the determined predictive model may need to be updated.

By sending the second indication in this Action 307, the second node 112 may enable the first node 111 to obtain feedback about the accuracy of the determined predictive model, and, e.g., enable the first node 111 to determine whether or not to update the determined predictive model itself, or as indicated by the second node 112.

Embodiments of a computer-implemented method performed by the third node 113 will now be described with reference to the flowchart depicted in FIG. 4. The method may be understood to be for handling a need to page a device. The third node 113 operates in the communications network 10.

The method may comprise the following actions. Several embodiments are comprised herein. In some embodiments, some actions may be performed, in other embodiments, all actions may be performed. One or more embodiments may be combined, where applicable. All possible combinations are not described to simplify the description. It should be noted that the examples herein are not mutually exclusive. Components from one example may be tacitly assumed to be present in another example and it will be obvious to a person skilled in the art how those components may be used in the other examples. In FIG. 4, optional actions are represented in boxes with dashed lines.

The detailed description of some of the following corresponds to the same references provided above, in relation to the actions described for the first node 111 and will thus not be repeated here to simplify the description. For example, in some particular examples, the third node 113 may be the same node as the first node 111. In other particular examples, the third node 113 may be an AMF.

Action 401

In this Action 401, the third node 113 may subscribe with the second node 112 for a service to receive the third indication.

By subscribing to receive the third indication in this Action 401, the third node 113 may be enabled to obtain the third indication in the next Action 402.

Action 402

In this Action 402, the third node 113, obtains the third indication from the second node 112 operating in the communications network 10. The third indication indicates the predicted future need to page the device 133 operating in the communications network 10.

Obtaining, which may be understood as e.g., receiving, may be performed, for example, via the third link 163.

In such examples, the third indication but may be the prediction notification. In some examples wherein the first node 111 may be the same as the second node 112, the third indication may be understood to be equivalent to some embodiments of the first indication.

By obtaining the third indication in this Action 402, predicting the need to page the device 133, the third node 113 be enabled to determine, based on the obtained third indication, whether or not to page the device 133 in the next Action 403.

Action 403

In this Action 403, the third node 113 determines, based on the obtained third indication, whether or not to page the device 133. The determining in this Action 403 may comprise to calculate a time to send a paging request to the device 133, based on the predicted need indicated by the third indication.

The third node 113 may request a paging for the device 133 based on the prediction that may have been indicated in the third indication. If the predictive model predicts a paging request to come at time=x, the third node 113 may determine to initiate a paging request at time=x−y, where y may be a value indicating the time it may normally take to find the device 133. The result may be that, at time=x, the device 133 may already be in connected mode. The downlink packet may immediately go to the device 133 without having to wait for paging. Note that the value y may be part of the predictive model, and thus changed based on the training data.

By determining whether or not to page the device 133 based on the third indication in this Action 403, the third node 113 may be understood to be enabled to page the device 133 ahead of the third time period so that whenever a downlink packet may arrive, the device 133 may already be in connected mode. This may be understood to then enable to avoid delay in packet delivery, which may otherwise be required to page the device 133 and set it in connected mode.

Action 404

In this Action 404, the third node 113 may send the second indication to the second node 112 or to the first node 111 operating in the communication network 10. The second indication may indicate at least one of: i) whether or not the device 133 was paged within the third time period, and ii) whether or not the device 133 was paged at another time period.

The sending may be performed, e.g., via the third link 163 to the second node 112, or via the second link 162 to the first node 111. The sending in this Action 404 may be directly to the first node 111, or via the second node 112.

By sending the second indication to the second node 112 or the to the first node 111 in this Action 404, the third node 113 may enable the first node 111 to determine whether or not to update the determined predictive model based on the obtained second indication and thereby to increase the accuracy of the predictive model. In turn, this may be understood to enable to avoid even in more occasions the delay in packet delivery, which may otherwise be required to page the device 133 and set it in connected mode.

The methods just described as being implemented by the first node 111, the second node 112, the third node 113, and the one or more other nodes 114 will now be described in further detail with specific non-limiting examples in the next two figures.

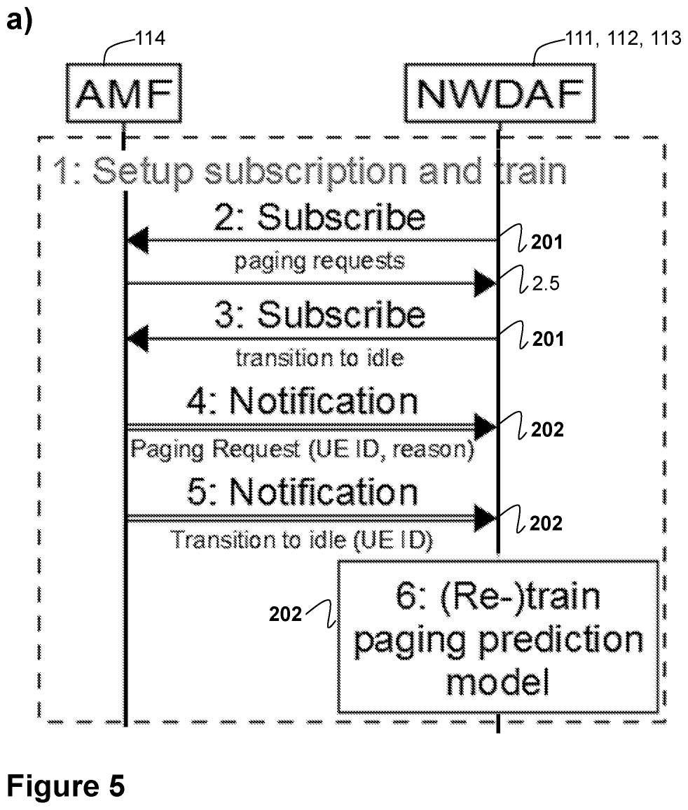

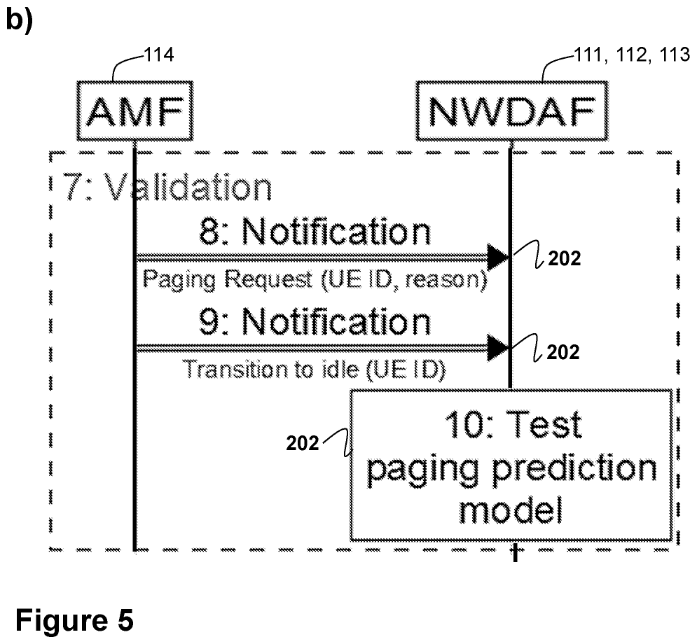

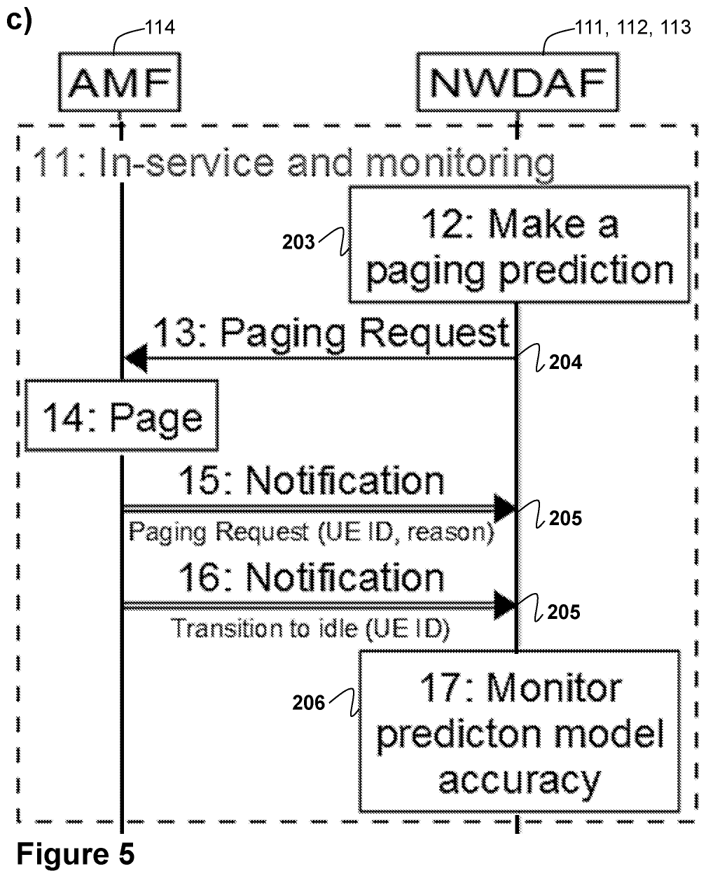

FIG. 5 is a signalling diagram in three panels a), b) and c), depicting a life cycle of the paging predictive model according to a non-limiting example of embodiments herein. In this non-limiting example, the first node 111 is the same as the second node 112 and the third node 113, that is, it is a node capable of building the predictive model, executing it to predict the future need to page the device 133, and determining whether or not to page the device 133. The first node 111 in this example is a NWDAF. In this non-limiting example, one of the one or more other nodes 114, referred to in this example as the fourth node 114, is an AMF, and the device 133 is a UE. The signalling flow in this non-limiting example is the following, according to the numbering depicted in FIG. 5. Panel a) of FIG. 5, as indicated at 1, describes the setup of the subscription and the training of the predictive model. At 2, the first node 111, in accordance with Action 201, subscribes with the fourth node 114 to receive notifications of paging requests for the one or more second devices 131, as an example of the first data. The subscription may be acknowledged by the fourth node 114 in the next signalling received from the fourth node 114 at 2.5. At 3, the first node 111, in accordance with Action 201, subscribes with the fourth node 114 to receive notifications of transitions to idle by the one or more second devices 131, as another example of the first data. At 4, according to Action 202, the first node 111 obtains the first data as a notification of a paging request comprising an identifier of the paged UE, of the one or more first devices 131, and the reason for the paging. At 5, according to Action 202, the first node 111 obtains the first data as a notification of a transition to idle of the UE, of the one or more first devices 131, comprising an identifier of the UE. Actions 4 and 5 may be understood to be repeated for each of the one or more first devices 131. At 6, according to Action 202, the first node 111 trains, which may also encompass re-training, the predictive model with the obtained first data. Panel b) of FIG. 5, as indicated at 7, describes procedure to validate the predictive model. At 8, the first node 111, in accordance with Action 202, obtains the second data as a notification of a paging request comprising an identifier of the paged UE, of the one or more second devices 132, and the reason for the paging. At 9, according to Action 202, the first node 111 obtains the second data as a notification of a transition to idle of the UE, of the one or more second devices 132, comprising an identifier of the UE. Actions 8 and 9 may be understood to be repeated for each of the one or more second devices 132. At 10, according to Action 202, the first node 111 tests the predictive model by determining if it is is ready to be used with the proviso that the accuracy exceeds a threshold, or continuing the training of the determined predictive model with the proviso that the accuracy is lower than the threshold. Panel c) of FIG. 5, as indicated at 11, describes the in-service and monitoring of the predictive model. At 12, the first node 111, in accordance with Action 203, predicts the need to page the device 133 in the third time period. At 13, according to Action 204, the first node 111 sends the first indication, here, a paging request, to one of the one or more other nodes 114. At 14, the fourth node 114 pages the device 133. At 15, in accordance with Action 205, first node 111 obtains the second indication, as a notification of the paging request sent to the device 133. The notification comprises an identifier of the device 133, as well as the reason for paging the device 133. At 16, in accordance with Action 205, the first node 111 obtains another example of the second indication, as a notification of the transition to idle of the device 133. The notification comprises the identifier of the device 133. Since the second indications may indicate whether or not the device 133 was paged within the third time period, or at another time period, at 17, according to Action 206, the first node 111 determines whether or not to update the determined predictive model based on the obtained second indications. This enables the first node 111 to monitor the accuracy of the predictive model. It may be understood that the second indications obtained by the first node 111 at 15 and 16 may be obtained as a result of the subscription to such services performed according to Action 201.

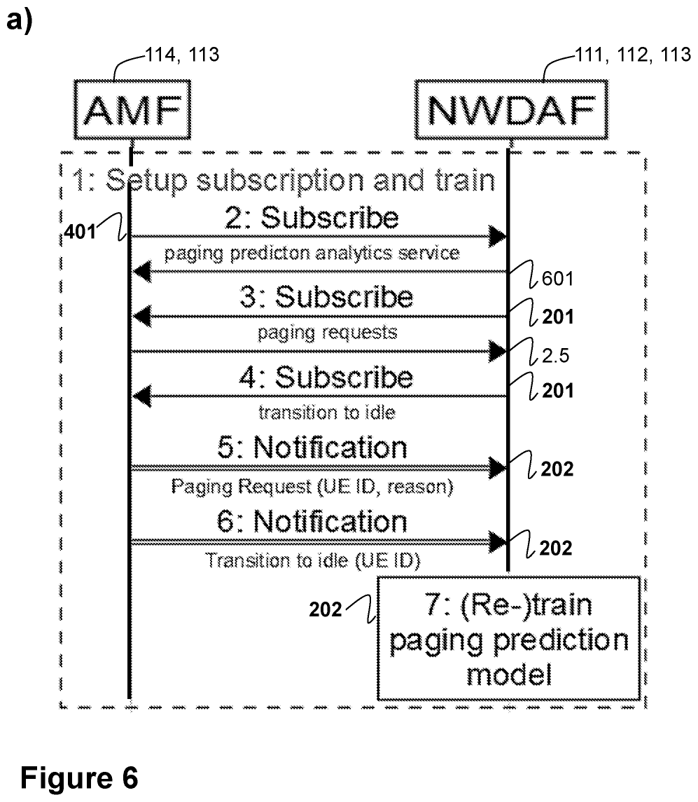

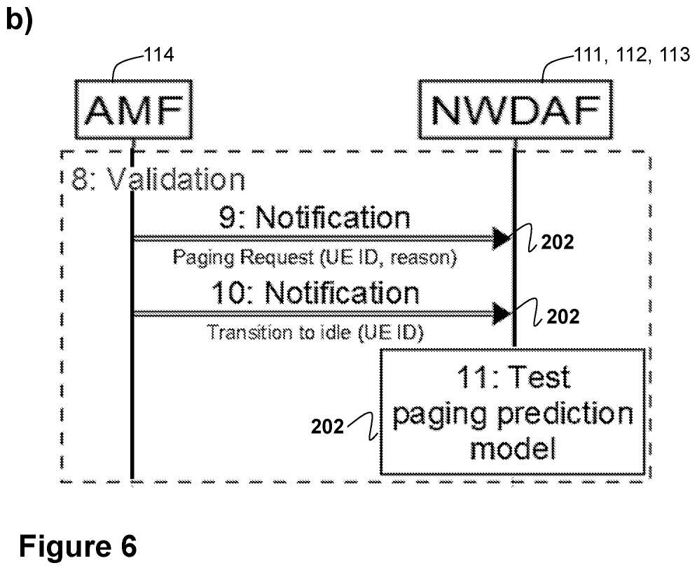

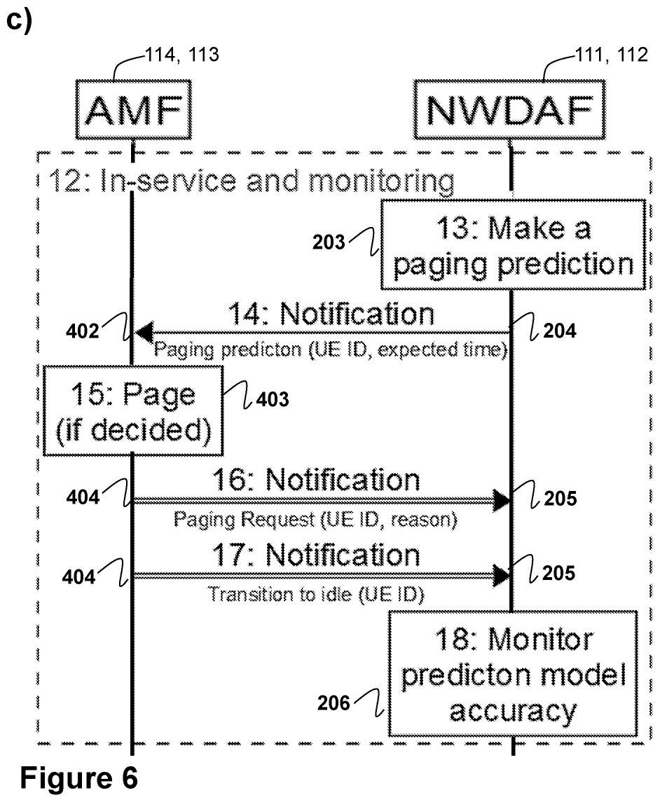

FIG. 6 is another signalling diagram in three panels a), b) and c), depicting another non-limiting example of embodiments herein, where an AMF may keep control of whether to page the device 133 or not. In this non-limiting example, the first node 111 is the same as the second node 112, that is, it is a node capable of building the predictive model and executing it to predict the future need to page the device 133. The first node 111 in this example is a NWDAF. In this non-limiting example, one of the one or more other nodes 114, referred to in this example as the fourth node 114, is the same as the third node 113, that is, it is a node capable of providing data about the device 133 and determining whether or not to page the device 133. The third node 113 in this example is an AMF. The device 133 is a UE. The signalling flow in this non-limiting example is the following, according to the numbering depicted in FIG. 6. Panel a) of FIG. 6, as indicated at 1, describes the setup of the subscription and the training of the predictive model. At 2, the third node 113, in accordance with Action 401, subscribes with the first node 111 for the service to receive the third indication, here referred to as a “paging prediction analytics service”. The subscription may be acknowledged by the first node 111 in the next signalling received from the third node 113 at 601. Actions 3-7 are performed as described in FIG. 5 for Actions 2-6, respectively. Action 2.5 corresponds to Action 2.5 in FIG. 5. Panel b) of FIG. 6, as indicated at 8, describes procedure to validate the predictive model. Actions 9-11 are performed as described in FIG. 5 for Actions 8-10, respectively. Panel c) of FIG. 6, as indicated at 12, describes the in-service and monitoring of the predictive model. At 13, the first node 111, in accordance with Action 203, predicts the need to page the device 133 in the third time period. At 14, according to Action 204, the first node 111 sends the first indication, here, a notification of a predicted future need to page the device 133 based on the predictive model. The first indication comprises an identifier for the device 133 and the expected time of when the paging may be needed. The third node 113 obtains the first indication as the third indication, in accordance with Action 402. At 15, in accordance with Action 403, the third node 113 determines, based on the obtained third indication, whether or not to page the device 133, and pages the device 133 according to the determination. That is, it only pages the device 133 if it decides that it has to do so. At 16, in accordance with Action 404, the third node 113 sends one example of the second indication to the first node 111, which receives it in accordance with Action 205. In this example, the second indication is a notification of the paging request sent to the device 133. The notification comprises an identifier of the device 133, as well as the reason for paging the device 133. At 16, in accordance with Action 404, the third node 113 sends another example of the second indication to the first node 111, which receives it in accordance with Action 205. In this other example, the second indication is a notification of the transition to idle of the device 133. The notification comprises the identifier of the device 133. Since the second indications may indicate whether or not the device 133 was paged within the third time period, or at another time period, at 18, according to Action 206, the first node 111 determines whether or not to update the determined predictive model based on the obtained second indications as described in FIG. 5 for Action 17.

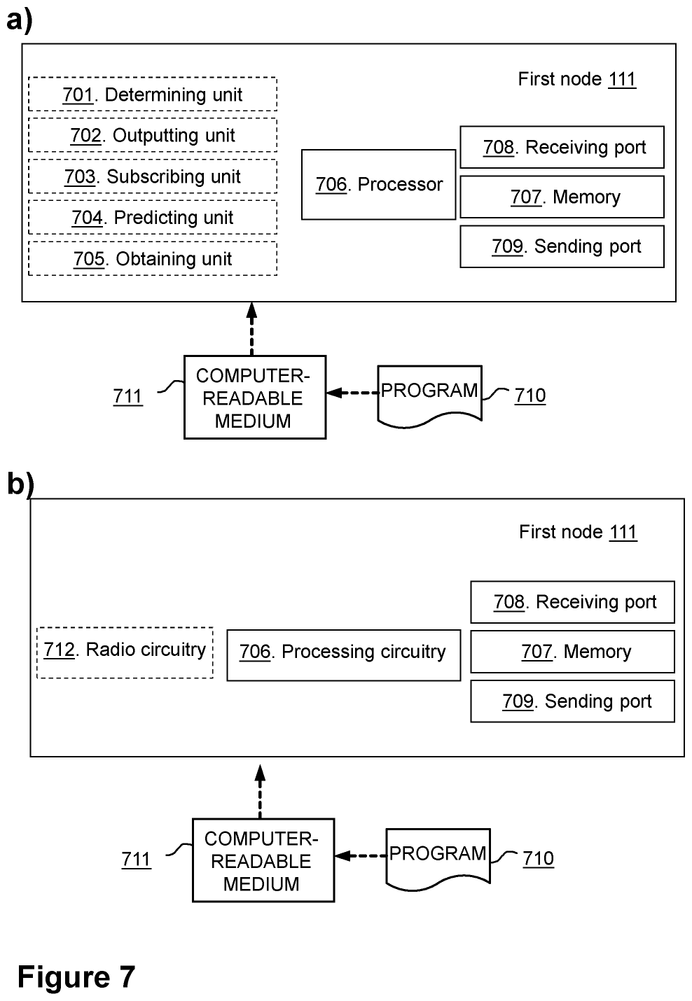

FIG. 7 depicts two different examples in panels a) and b), respectively, of the arrangement that the first node 111 may comprise to perform the method actions described above in relation to FIG. 2, FIG. 5 and FIG. 6. In some embodiments, the first node 111 may comprise the following arrangement depicted in FIG. 7a. The first node 111 may be understood to be for handling a need to page the device 133. The first node 111 is configured to operate in the communications network 10.

Several embodiments are comprised herein. Components from one embodiment may be tacitly assumed to be present in another embodiment and it will be obvious to a person skilled in the art how those components may be used in the other exemplary embodiments. In FIG. 7, optional boxes are indicated by dashed lines. The detailed description of some of the following corresponds to the same references provided above, in relation to the actions described for the first node 111 and will thus not be repeated here. For example, the first node 111 may be configured to be a NWDAF, and the at least one of the one or more other nodes 114 may be configured to be one of an AMF, and a CU-CP.

The first node 111 is configured to, e.g. by means of a determining unit 701 within the first node 111 configured to, determine the predictive model of the future need to page the device 133 configured to operate in the communications network 10.

The first node 111 is also configured to, e.g. by means of an outputting unit 702 within the first node 111 configured to, output the first indication. The first indication may be configured to be based on the predictive model configured to be determined.

In some embodiments, the first indication may be configured to indicate one of: the predictive model configured to be determined, the future need to page the device 133 configured to be predicted, the instruction to page the device 133 and the recommendation to page the device 133.

In some embodiments, to determine the predictive model may be configured to be performed using machine learning. To determine may further comprise performing iteratively: obtaining the first data and training the predictive model based on the first data configured to be obtained. The first data may be configured to indicate one or more of: a) the first paging requests configured to be sent to one or more first devices 131 over the first time period, the one or more first devices 131 configured to be operating, or configured to have operated, in the communications network 10, b) the first transitions by the one or more first devices 131, over the first time period, between the first state wherein the one or more first devices 131 had an active connection with the communications network 10 and the second state wherein the one or more first devices 131 had a standby connection with the communications network 10, c) the first mobility pattern of the one or more first devices 131, d) the first location of the one or more first devices 131, e) the first pattern of communications by the one or more first devices 131 in the communications network 10, the communications being configured to be at least one of control communications and user plane communications, and f) the first services used by the one or more first devices 131 in the communications network 10.

In some embodiments, the first node 111 may be configured to, e.g. by means of a subscribing unit 703 within the first node 111 configured to, subscribe with one or more other nodes 114 to receive the first data from the one or more first devices 131 configured to operate in the communications network 10.

In some embodiments, to determine the predictive model may be configured to further comprise performing iteratively: i) testing the accuracy of the predictive model configured to be with second data, and one of: ii) determining the predictive model configured to be determined is ready to be used with the proviso that the accuracy is configured to exceed a threshold, and iii) continuing the training of the determined predictive model with the proviso that the accuracy is configured to be lower than the threshold. The second data may be configured to indicate one or more of: a) the second paging requests sent to the one or more second devices 132 configured to operate, or configured to have operated, in the communications network 10 over a second time period, b) the second transitions by the one or more second devices 132, over the second time period, from the first state wherein the one or more second devices 132 had an active connection with the communications network 10 to the second state wherein the one or more second devices 132 had a standby connection with the communications network 10, c) the second mobility pattern of the one or more second devices 132, d) the second location of the one or more second devices 132, e) the second pattern of communications by the one or more second devices 132 in the communications network 10, and f) the second services used by the one or more second devices 132 in the communications network 10.

In some embodiments, the first node 111 may be configured to, e.g. by means of a predicting unit 704 within the first node 111 configured to, predict the need to page the device 133 in a third time period based on the predictive model configured to be determined, and wherein the first indication configured to be output is configured to be based on the need configured to be predicted. In such embodiments, the accuracy may be configured to exceed the threshold.

In some embodiments, the first node 111 may be configured to, e.g. by means of an obtaining unit 705 within the first node 111 configured to, obtain the second indication. The second indication may be configured to indicate at least one of: i) whether or not the device 133 was paged within the third time period, and ii) whether or not the device 133 was paged at another time period.

In some embodiments, e.g., such as those of the previous paragraph, the first node 111 may be further configured to, e.g. by means of the determining unit 701 configured to, determine whether or not to update the predictive model configured to be determined based on the second indication configured to be obtained.

In some embodiments, to output may be configured to comprise sending the first indication to one of: a) the second node 112 configured to operate in the communications network 10, wherein the first indication may be configured to indicate the predictive model configured to be determined, b) the third node 113 configured to operate in the communications network 10, wherein the first indication may be configured to indicate the future need configured to be predicted to page the device 133 based on the model configured to be predicted, and c) at least one of the one or more other nodes 114 configured to operate in the communications network 10. The at least one of the one or more other nodes 114 may be configured to have subscribed to receive the first indication. To output may be configured to be based on the subscription configured to be received.

In some embodiments, the first data may be configured to comprise at least one of: the respective first time paging started, the respective identifier of the one or more first devices 131, the respective second time period it took to locate the one or more first devices 131 and the respective reason for paging.

In some embodiments, the first state may be configured to be the connected state and the second state may be configured to be one of: idle, inactive and dormant.

The embodiments herein may be implemented through one or more processors, such as a processor 706 in the first node 111 depicted in FIG. 7, together with computer program code for performing the functions and actions of the embodiments herein. The program code mentioned above may also be provided as a computer program product, for instance in the form of a data carrier carrying computer program code for performing the embodiments herein when being loaded into the in the first node 111. One such carrier may be in the form of a CD ROM disc. It is however feasible with other data carriers such as a memory stick. The computer program code may furthermore be provided as pure program code on a server and downloaded to the first node 111.

The first node 111 may further comprise a memory 707 comprising one or more memory units. The memory 707 is arranged to be used to store obtained information, store data, configurations, schedulings, and applications etc. to perform the methods herein when being executed in the first node 111.

In some embodiments, the first node 111 may receive information from, e.g., the one or more other nodes 114, the second node 112, the third node 113 the one or more first devices 131, the one or more second devices 132 and/or the device 133 through a receiving port 708. In some examples, the receiving port 708 may be, for example, connected to one or more antennas in the first node 111. In other embodiments, the first node 111 may receive information from another structure in the communications network 10 through the receiving port 708. Since the receiving port 708 may be in communication with the processor 706, the receiving port 708 may then send the received information to the processor 706. The receiving port 708 may also be configured to receive other information.

The processor 706 in the first node 111 may be further configured to transmit or send information to e.g., the one or more other nodes 114, the second node 112, the third node 113 the one or more first devices 131, the one or more second devices 132, the device 133 and/or another structure in the communications network 10, through a sending port 709, which may be in communication with the processor 706, and the memory 707.

Those skilled in the art will also appreciate that any of the units 701-705 described above may refer to a combination of analog and digital circuits, and/or one or more processors configured with software and/or firmware, e.g., stored in memory, that, when executed by the one or more processors such as the processor 706, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Any of the units 701-705 described above may be the processor 706 of the first node 111, or an application running on such processor.

Thus, the methods according to the embodiments described herein for the first node 111 may be respectively implemented by means of a computer program 710 product, comprising instructions, i.e., software code portions, which, when executed on at least one processor 706, cause the at least one processor 706 to carry out the actions described herein, as performed by the first node 111. The computer program 710 product may be stored on a computer-readable storage medium 711. The computer-readable storage medium 711, having stored thereon the computer program 710, may comprise instructions which, when executed on at least one processor 706, cause the at least one processor 706 to carry out the actions described herein, as performed by the first node 111. In some embodiments, the computer-readable storage medium 711 may be a non-transitory computer-readable storage medium, such as a CD ROM disc, a memory stick, or stored in the cloud space. In other embodiments, the computer program 710 product may be stored on a carrier containing the computer program, wherein the carrier is one of an electronic signal, optical signal, radio signal, or the computer-readable storage medium 711, as described above.

The first node 111 may comprise an interface unit to facilitate communications between the first node 111 and other nodes or devices, e.g., the one or more other nodes 114, the second node 112, the third node 113 the one or more first devices 131, the one or more second devices 132, the device 133 and/or another structure in the communications network 10. In some particular examples, the interface may, for example, include a transceiver configured to transmit and receive radio signals over an air interface in accordance with a suitable standard.

In other embodiments, the first node 111 may comprise the following arrangement depicted in FIG. 7b. The first node 111 may comprise a processing circuitry 706, e.g., one or more processors such as the processor 706, in the first node 111 and the memory 707. The first node 111 may also comprise a radio circuitry 712, which may comprise e.g., the receiving port 708 and the sending port 709. The processing circuitry 706 may be configured to, or operable to, perform the method actions according to FIG. 2, FIG. 5 and/or FIG. 6 in a similar manner as that described in relation to FIG. 7a. The radio circuitry 712 may be configured to set up and maintain at least a wireless connection with the one or more other nodes 114, the second node 112, the third node 113 the one or more first devices 131, the one or more second devices 132, the device 133 and/or another structure in the communications network 10.

Hence, embodiments herein also relate to the first node 111 operative to handle a need to page the device 133, the first node 111 being operative to operate in the communications network 10. The first node 111 may comprise the processing circuitry 706 and the memory 707, said memory 707 containing instructions executable by said processing circuitry 706, whereby the first node 111 is further operative to perform the actions described herein in relation to the first node 111, e.g., in FIG. 2, FIG. 5 and/or FIG. 6.

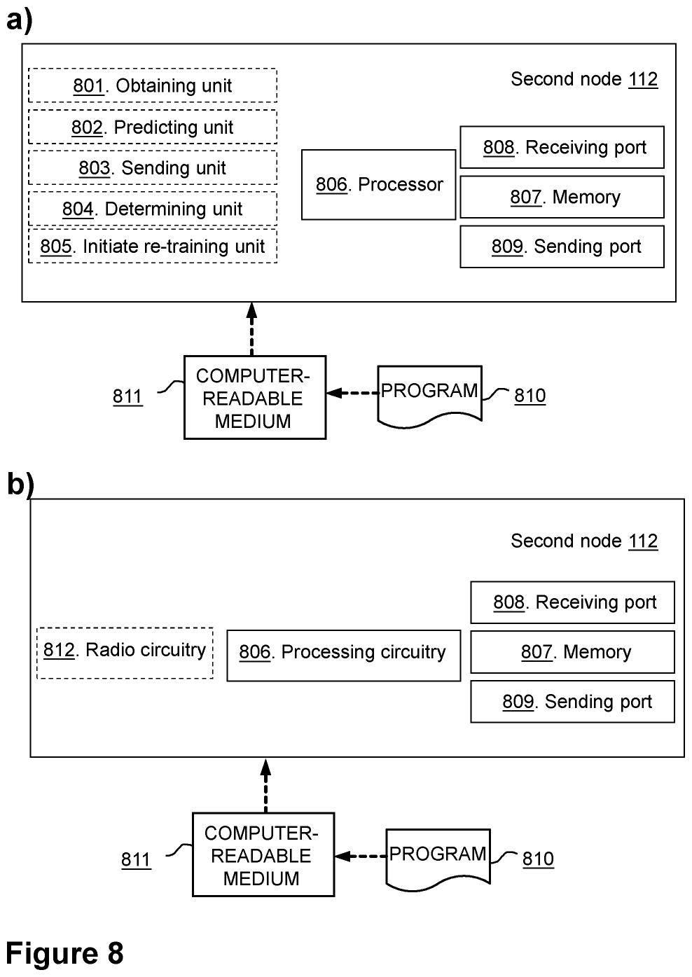

FIG. 8 depicts two different examples in panels a) and b), respectively, of the arrangement that the second node 112 may comprise to perform the method actions described above in relation to FIG. 3, FIG. 5 and/or FIG. 6. In some embodiments, the second nodes 112 may comprise the following arrangement depicted in FIG. 8a. The one or more second nodes 112 may be configured to handle the need to page the device 133. The second node 112 is configured to operate in the communications network 10.

Several embodiments are comprised herein. Components from one embodiment may be tacitly assumed to be present in another embodiment and it will be obvious to a person skilled in the art how those components may be used in the other exemplary embodiments. In FIG. 8, optional boxes are indicated by dashed lines. The detailed description of some of the following corresponds to the same references provided above, in relation to the actions described for the second node 112 and will thus not be repeated here. For example, the first node 111 may be configured to be a NWDAF.

The second node 112 is configured to, e.g. by means of an obtaining unit 801 within the second node 112 configured to, obtain the first indication from the first node 111 configured to operate in the communications network 10. The first indication may be configured to indicate the determined predictive model of the future need to page the device 133 configured to operate in the communications network 10.

The second node 112 is also configured to, e.g. by means of a predicting unit 802 within the second node 112 configured to, predict, based on the first indication configured to be obtained, the future need to page the device 133.

In some embodiments, the second node 112 may be configured to, e.g. by means of a sending unit 803 within the second node 112 configured to, send the third indication to the third node 113 configured to operate in the communications network 10. The third indication may be configured to indicate the need to page the device 133 configured to be predicted.

The second node 112 may be configured to, e.g. by means of the obtaining unit 801 within the second node 112 configured to, obtain the second indication. The second indication may be configured to indicate, e.g., explicitly or implicitly, at least one of: i) whether or not the device 133 was paged within the third time period, and ii) whether or not the device 133 was paged at another time period. The second indication may be configured to be obtained from any of the one or more other nodes 114, or the third node 113, e.g., an AMF.

The second node 112 may be configured to, e.g. by means of a determining unit 804 configured to determine whether or not to update the determined predictive model based on the second indication configured to be obtained.

The second node 112 may be configured to determine to update the determined predictive model if the second indication configured to be obtained is configured to indicate that the prediction configured to be made by the second node 112 was incorrect.

The second node 111 may be configured to, e.g. by means of a initiating re-training unit 805 configured to, initiate retraining the determined predictive model based on a result of the determination of whether or not to update the determined predictive model based on the second indication configured to be obtained. The second node 112 may be configured to perform the re-training itself, or to indicate to the first node 111 that the predictive model should be updated. If the second indication configured to be obtained is configured to indicate that the prediction configured to be made by the second node 112 was correct, the second node 112 may be configured to determine to refrain from updating the determined predictive model, and may be further configured to continue to e.g., make predictions based on it.

The second node 112 may be configured to, e.g. by means of the sending unit 803 within the second node 112 configured to, send the second indication, as configured to be obtained, or modified, to the first node 111. The second indication may be configured to indicate, e.g., explicitly or implicitly, at least one of: i) whether or not the device 133 was paged within the third time period, and ii) whether or not the device 133 was paged at another time period. The second indication may in some examples, be configured to be based on a result of the determination configured to be performed, and indicate, e.g., that the predictive model configured to be determined may need to be updated.

The embodiments herein may be implemented through one or more processors, such as a processor 806 in the second node 112 depicted in FIG. 8, together with computer program code for performing the functions and actions of the embodiments herein. The program code mentioned above may also be provided as a computer program product, for instance in the form of a data carrier carrying computer program code for performing the embodiments herein when being loaded into the in the second node 112. One such carrier may be in the form of a CD ROM disc. It is however feasible with other data carriers such as a memory stick. The computer program code may furthermore be provided as pure program code on a server and downloaded to the second node 112.

The second node 112 may further comprise a memory 807 comprising one or more memory units. The memory 807 is arranged to be used to store obtained information, store data, configurations, schedulings, and applications etc. to perform the methods herein when being executed in the second node 112.

In some embodiments, the second node 112 may receive information from, e.g., the one or more other nodes 114, the first node 111, the third node 113 the one or more first devices 131, the one or more second devices 132 and/or the device 133, through a receiving port 808. In some examples, the receiving port 808 may be, for example, connected to one or more antennas in the second node 112. In other embodiments, the second node 112 may receive information from another structure in the communications network 10 through the receiving port 808. Since the receiving port 808 may be in communication with the processor 806, the receiving port 808 may then send the received information to the processor 806. The receiving port 808 may also be configured to receive other information.

The processor 806 in the second node 112 may be further configured to transmit or send information to e.g., the one or more other nodes 114, the first node 111, the third node 113 the one or more first devices 131, the one or more second devices 132, the device and/or 133 another structure in the communications network 10, through a sending port 809, which may be in communication with the processor 806, and the memory 807.

Those skilled in the art will also appreciate that any of the units 801-804 described above may refer to a combination of analog and digital circuits, and/or one or more processors configured with software and/or firmware, e.g., stored in memory, that, when executed by the one or more processors such as the processor 806, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Any of the units 801-804 described above may be the processor 806 of the second node 112, or an application running on such processor.

Thus, the methods according to the embodiments described herein for the second node 112 may be respectively implemented by means of a computer program 810 product, comprising instructions, i.e., software code portions, which, when executed on at least one processor 806, cause the at least one processor 806 to carry out the actions described herein, as performed by the second node 112. The computer program 810 product may be stored on a computer-readable storage medium 811. The computer-readable storage medium 811, having stored thereon the computer program 810, may comprise instructions which, when executed on at least one processor 806, cause the at least one processor 806 to carry out the actions described herein, as performed by the second node 112. In some embodiments, the computer-readable storage medium 811 may be a non-transitory computer-readable storage medium, such as a CD ROM disc, a memory stick, or stored in the cloud space. In other embodiments, the computer program 810 product may be stored on a carrier containing the computer program, wherein the carrier is one of an electronic signal, optical signal, radio signal, or the computer-readable storage medium 811, as described above.

The second node 112 may comprise an interface unit to facilitate communications between the second node 112 and other nodes or devices, e.g., the one or more other nodes 114, the first node 111, the third node 113 the one or more first devices 131, the one or more second devices 132, the device and/or 133 another structure in the communications network 10. In some particular examples, the interface may, for example, include a transceiver configured to transmit and receive radio signals over an air interface in accordance with a suitable standard.

In other embodiments, the second node 112 may comprise the following arrangement depicted in FIG. 8b. The second node 112 may comprise a processing circuitry 806, e.g., one or more processors such as the processor 806, in the second node 112 and the memory 807. The second node 112 may also comprise a radio circuitry 812, which may comprise e.g., the receiving port 808 and the sending port 809. The processing circuitry 806 may be configured to, or operable to, perform the method actions according to FIG. 3, FIG. 5 and/or FIG. 6, in a similar manner as that described in relation to FIG. 8a. The radio circuitry 812 may be configured to set up and maintain at least a wireless connection with the one or more other nodes 114, the first node 111, the third node 113 the one or more first devices 131, the one or more second devices 132, the device and/or 133 another structure in the communications network 10.

Hence, embodiments herein also relate to the second node 112 operative to handle the need to page the device 133, the second node 112 being operative to operate in the communications network 10. The second node 112 may comprise the processing circuitry 806 and the memory 807, said memory 807 containing instructions executable by said processing circuitry 806, whereby the second node 112 is further operative to perform the actions described herein in relation to the second node 112, e.g., in FIG. 3, FIG. 5 and/or FIG. 6.

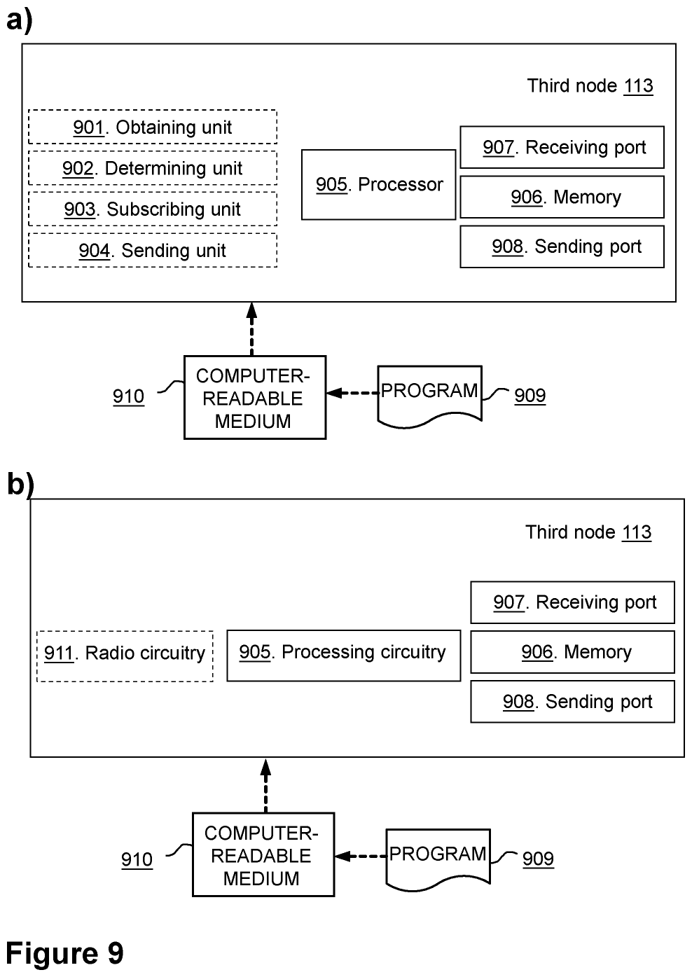

FIG. 9 depicts two different examples in panels a) and b), respectively, of the arrangement that the third node 113 may comprise to perform the method actions described above in relation to FIG. 4, FIG. 5 and/or FIG. 6. In some embodiments, the third node 113 may comprise the following arrangement depicted in FIG. 9a. The third node 113 may be configured to handle the need to page the device 133. The third node 113 is configured to operate in the communications network 10.

Several embodiments are comprised herein. Components from one embodiment may be tacitly assumed to be present in another embodiment and it will be obvious to a person skilled in the art how those components may be used in the other exemplary embodiments. In FIG. 9, optional boxes are indicated by dashed lines. The detailed description of some of the following corresponds to the same references provided above, in relation to the actions described for the third node 113 and will thus not be repeated here. For example, the first node 111 may be configured to be a NWDAF.

The third node 113 is configured to, e.g. by means of an obtaining unit 901 within the third node 113 configured to, obtain the third indication from the second node 112 configured to operate in the communications network 10. The third indication may be configured to indicate the predicted future need to page the device 133 configured to operate in the communications network 10.

The third node 113 is also configured to, e.g. by means of a determining unit 902 within the third node 113 configured to, determine, based on the third indication configured to be obtained, whether or not to page the device 133.

The third node 113 may be also configured to, e.g. by means of a subscribing unit 903 within the third node 113 configured to, subscribe with the second node 112 for the service to receive the third indication.

The third node 113 may be also configured to, e.g. by means of a sending unit 904 within the third node 113 configured to, send the second indication to the second node 112 or to the first node 111 configured to operate in the communication network 10. The second indication may be configured to indicate at least one of: i) whether or not the device 133 was paged within the third time period, and ii) whether or not the device 133 was paged at another time period.

The embodiments herein may be implemented through one or more processors, such as a processor 905 in the third node 113 depicted in FIG. 9, together with computer program code for performing the functions and actions of the embodiments herein. The program code mentioned above may also be provided as a computer program product, for instance in the form of a data carrier carrying computer program code for performing the embodiments herein when being loaded into the in the third node 113. One such carrier may be in the form of a CD ROM disc. It is however feasible with other data carriers such as a memory stick. The computer program code may furthermore be provided as pure program code on a server and downloaded to the third node 113.

The third node 113 may further comprise a memory 906 comprising one or more memory units. The memory 906 is arranged to be used to store obtained information, store data, configurations, schedulings, and applications etc. to perform the methods herein when being executed in the third node 113.

In some embodiments, the third node 113 may receive information from, e.g., the one or more other nodes 114, the second node 112, the first node 111, the one or more first devices 131, the one or more second devices 132 and/or the device 133, through a receiving port 907. In some examples, the receiving port 907 may be, for example, connected to one or more antennas in the third node 113. In other embodiments, the third node 113 may receive information from another structure in the communications network 10 through the receiving port 907. Since the receiving port 907 may be in communication with the processor 905, the receiving port 907 may then send the received information to the processor 905. The receiving port 907 may also be configured to receive other information.

The processor 905 in the third node 113 may be further configured to transmit or send information to e.g., the one or more other nodes 114, the second node 112, the first node 111, the one or more first devices 131, the one or more second devices 132, the device 133 and/or another structure in the communications network 10, through a sending port 908, which may be in communication with the processor 905, and the memory 906.

Those skilled in the art will also appreciate that the any of the units 901-904 described above may refer to a combination of analog and digital circuits, and/or one or more processors configured with software and/or firmware, e.g., stored in memory, that, when executed by the one or more processors such as the processor 905, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Any of the d units 901-904 described above may be the processor 905 of the third node 113, or an application running on such processor.

Thus, the methods according to the embodiments described herein for the third node 113 may be respectively implemented by means of a computer program 909 product, comprising instructions, i.e., software code portions, which, when executed on at least one processor 905, cause the at least one processor 905 to carry out the actions described herein, as performed by the third node 113. The computer program 909 product may be stored on a computer-readable storage medium 910. The computer-readable storage medium 910, having stored thereon the computer program 909, may comprise instructions which, when executed on at least one processor 905, cause the at least one processor 905 to carry out the actions described herein, as performed by the third node 113. In some embodiments, the computer-readable storage medium 910 may be a non-transitory computer-readable storage medium, such as a CD ROM disc, a memory stick, or stored in the cloud space. In other embodiments, the computer program 909 product may be stored on a carrier containing the computer program, wherein the carrier is one of an electronic signal, optical signal, radio signal, or the computer-readable storage medium 910, as described above.

The third node 113 may comprise an interface unit to facilitate communications between the third node 113 and other nodes or devices, e.g., the one or more other nodes 114, the second node 112, the first node 111, the one or more first devices 131, the one or more second devices 132, the device 133 and/or another structure in the communications network 10. In some particular examples, the interface may, for example, include a transceiver configured to transmit and receive radio signals over an air interface in accordance with a suitable standard.

In other embodiments, the third node 113 may comprise the following arrangement depicted in FIG. 9b. The third node 113 may comprise a processing circuitry 905, e.g., one or more processors such as the processor 905, in the third node 113 and the memory 906. The third node 113 may also comprise a radio circuitry 911, which may comprise e.g., the receiving port 907 and the sending port 908. The processing circuitry 905 may be configured to, or operable to, perform the method actions according to FIG. 4, FIG. 5 and/or FIG. 6, in a similar manner as that described in relation to FIG. 9a. The radio circuitry 911 may be configured to set up and maintain at least a wireless connection with the one or more other nodes 114, the second node 112, the first node 111, the one or more first devices 131, the one or more second devices 132, the device 133 and/or another structure in the communications network 10.

Hence, embodiments herein also relate to the third node 113 operative to handle the need to page the device 133, the third node 113 being operative to operate in the communications network 10. The third node 113 may comprise the processing circuitry 905 and the memory 906, said memory 906 containing instructions executable by said processing circuitry 905, whereby the third node 113 is further operative to perform the actions described herein in relation to the third node 113, e.g., in FIG. 4, FIG. 5 and/or FIG. 6.

When using the word “comprise” or “comprising”, it shall be interpreted as non-limiting, i.e. meaning “consist at least of”.

The embodiments herein are not limited to the above described preferred embodiments. Various alternatives, modifications and equivalents may be used. Therefore, the above embodiments should not be taken as limiting the scope of the invention.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

As used herein, the expression “at least one of:” followed by a list of alternatives separated by commas, and wherein the last alternative is preceded by the “and” term, may be understood to mean that only one of the list of alternatives may apply, more than one of the list of alternatives may apply or all of the list of alternatives may apply. This expression may be understood to be equivalent to the expression “at least one of:” followed by a list of alternatives separated by commas, and wherein the last alternative is preceded by the “or” term.

Any of the terms processor and circuitry may be understood herein as a hardware component.

As used herein, the expression “in some embodiments” has been used to indicate that the features of the embodiment described may be combined with any other embodiment or example disclosed herein.

As used herein, the expression “in some examples” has been used to indicate that the features of the example described may be combined with any other embodiment or example disclosed herein.

1-44. (canceled)

45. A computer-implemented method, performed by a first node, the first node operating in a communications network, the method comprising:
determining a predictive model of a future need to page a device operating in the communications network, and
outputting a first indication, the first indication being based on the determined predictive model.

46. The method according to claim 45, wherein the first indication indicates one of:
the determined predictive model, a predicted future need to page the device, an instruction to page the device and a recommendation to page the device.

47. The method according to claim 45, wherein the determining is performed using machine learning, and wherein the determining further comprises performing iteratively:
obtaining first data indicating one or more of:
first paging requests sent to one or more first devices over a first time period, the one or more first devices operating, or having operated, in the communications network,
first transitions by the one or more first devices, over the first time period, between a first state wherein the one or more first devices had an active connection with the communications network and a second state wherein the one or more first devices had a standby connection with the communications network,
a first mobility pattern of the one or more first devices,
a first location of the one or more first devices,
a first pattern of communications by the one or more first devices in the communications network, the communications being at least one of control communications and user plane communications,
first services used by the one or more first devices in the communications network, and
training the predictive model based on the obtained first data.

48. The method according to claim 47, further comprising:
subscribing with one or more other nodes to receive the first data from the one or more first devices in the communications network.

49. The method according to claim 47, wherein the determining further comprises performing iteratively:
testing an accuracy of the determined predictive model with second data indicating one or more of:
second paging requests sent to the one or more second devices operating, or having operated, in the communications network over a second time period,
second transitions by the one or more second devices, over the second time period, from the first state wherein the one or more second devices had an active connection with the communications network to the second state wherein the one or more second devices had a standby connection with the communications network,
a second mobility pattern of the one or more second devices,
a second location of the one or more second devices,
a second pattern of communications by the one or more second devices in the communications network, and
second services used by the one or more second devices in the communications network, and one of:
determining the determined predictive model is ready to be used with the proviso that the accuracy exceeds a threshold, and
continuing the training of the determined predictive model with the proviso that the accuracy is lower than the threshold.

50. The method according to claim 49, wherein the accuracy exceeds the threshold, and wherein the method further comprises:
predicting the need to page the device in a third time period based on the determined predictive model, and wherein the output first indication is based on the predicted need.

51. The method according to claim 45, wherein the method further comprises:
obtaining a second indication, the second indication indicating at least one of:
whether or not the device was paged within the third time period, and
whether or not the device was paged at another time period, and
determining whether or not to update the determined predictive model based on the obtained second indication.

52. The method according to claim 45, wherein the outputting comprises sending the first indication to one of:
a second node operating in the communications network, wherein the first indication indicates the determined predictive model,
a third node operating in the communications network, wherein the first indication indicates a predicted future need to page the device based on the predictive model, and
at least one of the one or more other nodes operating in the communications network, the at least one of the one or more other nodes having subscribed to receive the first indication, and wherein the outputting is based on the received subscription.

53. The method according to claim 52, wherein the first data comprises at least one of: a respective first time paging started, a respective identifier of the one or more first devices, a respective second time period it took to locate the one or more first devices and a respective reason for paging.

54. The method according to claim 52, wherein the first state is a connected state and the second state is one of: idle, inactive and dormant.

55. The method according to claim 45, wherein the first node is a Network Data Analytics Function, NWDAF, and the at least one of the one or more other nodes is one of an Access Management Function, AMF and a Centralized Unit—Control Plane, CU-CP.

56. A computer-implemented method, performed by a second node, the second node operating in a communications network, the method comprising:
obtaining a first indication from a first node operating in the communications network, the first indication indicating a determined predictive model of a future need to page a device operating in the communications network, and
predicting, based on the obtained first indication, the future need to page the device.

57. The method according to claim 56, wherein the method further comprises:
sending a third indication to a third node operating in the communications network, the third indication indicating the predicted need to page the device.

58. The method according to claim 56, wherein the method further comprises:
obtaining a second indication, the second indication indicating at least one of:
whether or not the device was paged within a third time period, and
whether or not the device was paged at another time period.

59. The method according to claim 56, wherein the method further comprises:
sending the obtained second indication to the first node.

60. The method according to claim 58, wherein the method further comprises:
determining whether or not to update the determined predictive model based on the obtained second indication, and
initiate re-training the determined predictive model based on a result of the determination of whether or not to update the determined predictive model based on the obtained second indication.

61. A computer-implemented method, performed by a third node, the third node operating in a communications network, the method comprising:
obtaining a third indication from a second node operating in the communications network, the third indication indicating a predicted future need to page a device operating in the communications network, and
determining, based on the obtained third indication, whether or not to page the device.

62. The method according to claim 61, further comprising:
subscribing with the second node for a service to receive the third indication.

63. The method according to claim 61, further comprising:
sending a second indication to the second node or to a first node operating in the communication network, the second indication indicating at least one of:
whether or not the device was paged within a third time period, and
whether or not the device was paged at another time period.
